(19) United States
(12) Patent Application Publication
(10) Pub. No.: US 2024/0205727 A1
(43) Pub. Date: Jun. 20, 2024

(54) Methods, Radio Network Nodes for Handling Communication

(71) Applicant: Telefonaktiebolaget LM Ericsson (publ), Stockholm (SE)

(72) Inventors: Marco Belleschi, Solna (SE); Filip Barac, Huddinge (SE); Ritesh Shreevastav, Upplands Väsby (SE)

(21) Appl. No.: 18/554,113

(22) PCT Filed: Apr. 6, 2022
(86) PCT No.: PCT/SE2022/050342

§ 371 Date: Oct. 5, 2023

Related U.S. Application Data
(60) Provisional application No. 63/171,653, filed on Apr. 7, 2021.

(51) Int. Cl. H04W 28/02; H04W 28/082; H04W 84/04

(52) U.S. Cl. CPC H04W 28/0236; H04W 28/082; H04W 84/047

(57) ABSTRACT

It is herein disclosed for example a method performed by a first radio network node (12) for handling communication in the wireless communications network (1). The first radio network node (12) transmits an indication to a second radio network node (16), indicating an obtained delay information for one or more channels associated with a second network node (15) that is conveying traffic that will be transmitted via the second radio network node (16), wherein the delay information indicates a delay between at least a plurality of network nodes. The first radio network node further receives a response from the second radio network node (16) indicating confirmation or rejection to be able to meet a requirement of delay as indicated by said transmitted indication.

### TECHNICAL FIELD

Embodiments herein relate to a first radio network node, a second radio network node, and methods performed therein regarding wireless communication. Furthermore, a computer program and a computer readable storage medium are also provided herein. In particular, embodiments herein relate to handling communication, such as controlling/managing load sharing or transferring for relay network nodes, in a wireless communications network.

### BACKGROUND

In a typical wireless communications network, user equipments (UE), also known as wireless communication devices, mobile stations, stations (STA) and/or wireless devices, communicate via a Radio Access Network (RAN) with one or more core networks (CN). The RAN covers a geographical area which is divided into service areas or cell areas, with each service area or cell area being served by radio network node such as an access node, e.g., a Wi-Fi access point or a radio base station (RBS), which in some networks may also be called, for example, a NodeB, a gNodeB, or an eNodeB. The service area or cell area is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases, such as 6G networks and development of 5G such as New Radio (NR). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the 5G technologies such as new radio (NR), the use of very many transmit—and receive—antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

The 3GPP has completed the integrated access and wireless access backhaul or Integrated Access Backhaul (IAB) in NR Rel-16 and is currently standardizing the IAB Rel-17.

The usage of short range mmWave spectrum in NR creates a need for densified deployment with multi-hop backhauling. However, optical fiber to every base station will be too costly and sometimes not even possible, e.g., historical sites. The main IAB principle is the use of wireless links for the backhaul, instead of fiber, to enable flexible and very dense deployment of cells without the need for densifying the transport network. Use case scenarios for IAB can include coverage extension, deployment of massive number of small cells and fixed wireless access (FWA), e.g., to residential/office buildings. The larger bandwidth available for NR in mmWave spectrum provides opportunity for self-backhauling, without limiting the spectrum to be used for the access links. On top of that, the inherent multi-beam and multiple input multiple output (MIMO) support in NR reduce cross-link interference between backhaul and access links allowing higher densification.

During the study item phase of the IAB work, summary of the study item can be found in the technical report TR 38.874 v.16.6.0, it has been agreed to adopt a solution that leverages a Central Unit (CU) and Distributed Unit (DU) split architecture of NR, where the IAB node will be hosting a DU part that is controlled by a central unit. The IAB nodes also have a Mobile Termination (MT) part that they use to communicate with their parent nodes.

The specifications for IAB strives to reuse existing functions and interfaces defined in NR. In particular, MT, gNB-DU, gNB-CU, user plane function (UPF), access and mobility management function (AMF) and session management function (SMF) as well as the corresponding interfaces NR Uu, between MT and gNB, F1, NG, X2 and N4 are used as baseline for the IAB architectures. Modifications or enhancements to these functions and interfaces for the support of IAB will be explained in the context of the architecture discussion. Additional functionality such as multi-hop forwarding is included in the architecture discussion as it is necessary for the understanding of IAB operation and since certain aspects may require standardization.

The MT function has been defined as a component of the IAB node. In the context of this study, MT is referred to as a function residing on an IAB-node that terminates the radio interface layers of the backhaul Uu interface toward the IAB-donor or other IAB-nodes.

FIG. 1 shows a reference diagram for IAB in standalone mode, which contains one IAB-donor and multiple IAB-nodes. The IAB-donor is treated as a single logical node that comprises a set of functions such as gNB-distributed unit (DU), gNB-central unit-control plane (CU-CP), gNB-central unit-user plane (CU-UP) and potentially other functions. In a deployment, the IAB-donor can be split according to these functions, which can all be either collocated or non-collocated as allowed by 3GPP NG-RAN architecture. IAB-related aspects may arise when such split is exercised. Also, some of the functions presently associated with the IAB-donor may eventually be moved outside of the donor in case it becomes evident that they do not perform IAB-specific tasks. Thus, FIG. 1 shows a high-level architectural view of an IAB network.

The baseline user plane and control plane protocol stacks for IAB are shown in the FIGS. 2 and 3.

As shown, the chosen protocol stacks reuse the current CU-DU split specification in Rel-15, where the full user plane F1-U (GTP-U/UDP/IP) is terminated at the IAB node, like a normal DU, and the full control plane F1-C(F1-AP/SCTP/IP) is also terminated at the IAB node, like a normal DU. In the above cases, Network Domain Security (NDS) has been employed to protect both user plane (UP) and control plane (CP) traffic, IP security (IPsec) in the case of UP, and Datagram Transport Layer Security (DTLS) in the case of CP. IPsec could also be used for the CP protection instead of DTLS, in this case no DTLS layer would be used.

A new protocol layer called Backhaul Adaptation Protocol (BAP) has been introduced in the IAB nodes and the IAB donor, which is used for routing of packets to the appropriate downstream and/or upstream node and also mapping the UE bearer data to the proper backhaul radio link control (RLC) channel, and also between ingress and egress backhaul (BH) RLC channels in intermediate IAB nodes, to satisfy the end to end quality of service (QoS) requirements of bearers. Therefore, the BAP layer is in charge of handling the BH RLC channel, e.g., to map an ingress BH RLC channel from a parent/child IAB node to an egress BH RLC channel in the link towards a child/parent IAB node.

In particular, one BH RLC channel may convey end-user traffic for several data radio bearers (DRB) and for different UEs which could be connected to different IAB nodes in the network. In 3GPP two possible configuration of BH RLC channel has been provided, i.e., a 1:1 mapping between BH RLC channel and a specific user's DRB, a N:1 bearer mapping where N DRBs possibly associated to different UEs are mapped to 1 BH RLC channel. The first case can be easily handled by the IAB node's scheduler since there is a 1:1 mapping between the QoS requirements of the BH RLC channel and the QoS requirements of the associated DRB. However, this type of 1:1 configuration is not easily scalable in case an IAB node is serving many UEs and/or DRBs. On the other hand, the N:1 configuration is more flexible or scalable, but ensuring fairness across the various served BH RLC channels might be trickier, because the amount of DRBs and/or UEs served by a given BH RLC channel might be different from the amount of DRBs and/or UEs served by another BH RLC channel.

### Bap Entities.

On the IAB-node, the BAP sublayer contains one BAP entity at the MT function and a separate co-located BAP entity at the DU function. On the IAB-donor-DU, the BAP sublayer contains only one BAP entity. Each BAP entity has a transmitting part and a receiving part. The transmitting part of the BAP entity has a corresponding receiving part of a BAP entity at the IAB-node or IAB-donor-DU across the backhaul link.

FIG. 4 shows one example of the functional view of the BAP sublayer. This functional view should not restrict implementation. The figure is based on the radio interface protocol architecture defined in TS 38.300 v.16.5.0. In the example of FIG. 4, the receiving part on the BAP entity delivers BAP protocol data units (PDU) to the transmitting part on the collocated BAP entity. Alternatively, the receiving part may deliver BAP service data units (SDU) to the collocated transmitting part. When passing BAP SDUs, the receiving part removes the BAP header, and the transmitting part adds the BAP header with the same BAP routing ID as carried on the BAP PDU header prior to removal. Passing BAP SDUs in this manner is therefore functionally equivalent to passing BAP PDUs, in implementation.

The following service is provided by the BAP sublayer to upper layers:
data transfer.

Services expected from lower layers.

A BAP sublayer expects the following services from lower layers per RLC entity, for a detailed description see TS 38.322 v16.2.0:
acknowledged data transfer service;
unacknowledged data transfer service.

### Functions.

The BAP sublayer supports the following functions:
Data transfer;
Determination of BAP destination and path for packets from upper layers;
Determination of egress BH RLC channels for packets routed to next hop;
Routing of packets to next hop;
Differentiating traffic to be delivered to upper layers from traffic to be delivered to egress link;
Flow control feedback and polling signalling;

Therefore, the BAP layer is fundamental to determine how to route a received packet. For the downstream that implies determining whether the packet has reached its final destination, in which case the packet will be transmitted to UEs that are connected to this IAB node as access node, or to forward it to another IAB node in the right path. In the first case, the BAP layer passes the packet to higher layers in the IAB node which are in charge of mapping the packet to the various QoS flows and hence DRBs which are included in the packet. In the second case instead, the BAP layer determines the proper egress BH RLC channel on the basis of the BAP destination, path IDs and ingress BH RLC channel. Same as the above applies also to the upstream, with the only difference that the final destination is always one specific donor DU/CU.

In order to achieve the above tasks, the BAP layer of the IAB node has to be configured with a routing table mapping ingress RLC channels to egress RLC channels which may be different depending on the specific BAP destination and path of the packet. Hence, the BAP destination and path ID are included in the header of the BAP packet so that the BAP layer can determine where to forward the packet.

Additionally, the BAP layer has an important role in the hop-by-hop flow control. In particular, a child node may inform a parent node about possible congestions experienced locally at the child node, so that the parent node can throttle the traffic towards the child node. The parent node can also use the BAP layer to inform the child node in case of radio link failure (RLF) issues experienced by the parent, so that the child can possibly reestablish its connection to another parent node.

Fulfilling latency requirements is obviously an issue in IAB networks, since a given packet needs to be potentially routed through several IAB nodes, i.e., hops, before reaching the intended UE. In an ordinary, i.e., non-IAB, network, each DRB/QoS flow may be associated to a certain Packet Delay Budget (PDB) that reflects the latency requirement of the traffic conveyed in such DRB or QoS flow and that the gNB scheduler needs to respect in order to avoid the packet being discarded at the receiver side, e.g. at the jitter buffer in the UE.

In case such PDB requirement cannot be respected, the gNB may decide to discard the concerned packet. In order to map such functionality in the IAB framework, the donor CU can provide each IAB node with the PDB related to a certain BH RLC channel. Since each BH RLC channel is associated to certain QoS characteristics, the scheduler residing in the IAB node knows how to treat the BH RLC channel such that the PDB that should be attained is respected. It should be noted that the PDB for non-IAB is service related, a PDB per type of service is specified. The PDB is one of the 5G QoS Identifier (5QI) parameters. The PDB is the delay counted from the user plane function (UPF) to the UE, minus the estimated delay between the core network and the access node, such as core network-packet delay budget (CN-PDB), see TS 23.501 v.16.8.0. Some fixed numbers for the CN-PDB are also provided in TS 23.501 v.16.8.0. The PDB that is specified for IAB is not service-based and is for a BH-RLC channel between the gNB-DU, IAB-donor DU, IAB-node DU, and the child IAB-MT. This means that the PDB that can be specified for IAB is per hop. In order to differentiate between the two PDBs used herein, the PDB that is specified in TS 23.501 v.16.8.0 is denoted as 5QI-PDB and the PDB for IAB is denoted as BH-PDB.

There are some topology adaptation scenarios for a baseline architecture. Topology adaptation in IAB networks may be needed for various reasons, e.g. changes in the radio conditions, changes to the load under the serving CU, radio link failures, etc. The consequence of an IAB topology adaptation could be that an IAB node is migrated, i.e., handed over, to a new parent, which may be controlled by the same or different CU, or that some traffic currently served by such IAB node is offloaded via a new route, which may be controlled by the same or different CU. If the new parent of the IAB node is under the same CU or a different CU, the migration is intra-donor and inter-donor one, respectively, herein also referred to as the intra-CU and inter-CU migration.

FIG. 5 shows an example of some possible IAB-node migration, i.e., topology adaptation, cases listed in the order of complexity, i.e., examples of different possible scenarios for IAB topology adaptation.

Intra-CU Case (A): In this case the IAB-node (e) along with its serving UEs is moved to a new parent node, IAB-node (b), under the same donor-DU (1). The successful intra-donor DU migration requires establishing UE context setup for the IAB-node (e) MT in the DU of the new parent node, IAB-node (b), updating routing tables of IAB nodes along the path to IAB-node (e) and allocating resources on the new path. The IP address for IAB-node (e) will not change, while the F1-U tunnel or connection between donor-CU (1) and IAB-node (e) DU will be redirected through IAB-node (b).

Intra-CU Case (B): The procedural requirements/complexity of this case is the same as that of Case (A). Also, since the new IAB-donor DU, i.e., DU2, is connected to

### Classification Systems

With reference to FIG. 10, a classification system and/or computer program product 1100 may be used in or by a platform, according to various embodiments described herein. A classification system and/or computer program product 1100 may be embodied as one or more enterprise, application, personal, pervasive and/or embedded computer systems that are operable to receive, transmit, process and store data using any suitable combination of software, firmware and/or hardware and that may be standalone and/or interconnected by any the same L2 network, the IAB-node (e) can use the same IP address under the new donor DU. However, the new donor DU, i.e., DU2, will need to inform the network using IAB-node (e) L2 address in order to get/keep the same IP address for IAB-node (e) by employing some mechanism such as Address Resolution Protocol (ARP).

Intra-CU Case (C): This case is more complex than Case (A) as it also needs allocation of new IP address for IAB-node (e). In case IPsec is used for securing the F1-U tunnel/connection between the Donor-CU (1) and IAB-node (e) DU, then it might be possible to use existing IP address along the path segment between the Donor-CU (1) and security gateway (SeGW), and new IP address for the IPsec tunnel between SeGW and IAB-node (e) DU.

Inter-CU Case (D): This is the most complicated case in terms of procedural requirements and may needs new specification procedures, such as enhancement of radio resource control (RRC), F1AP, XnAP, Ng signalling, that are beyond the scope of 3GPP Rel-16.

3GPP Rel-16 specifications only consider procedures for intra-CU migration. Inter-CU migration requires new signalling procedures between source and target CU in order to migrate the IAB node contexts and its traffic to the target CU, such that the IAB node operations can continue in the target CU and the QoS is not degraded. Inter-CU migration will be specified in the context of 3GPP Rel17.

During the intra-CU topology adaptation, both the source and the target parent node are served by the same IAB-donor-CU. The target parent node may use a different IAB-donor-DU than the source parent node. The source path may further have common nodes with the target path. FIG. 6 shows an example of the topology adaptation procedure, where the target parent node uses a different IAB-donor-DU than the source parent node.
1. The migrating IAB-MT sends a MeasurementReport message to the source parent node IAB-DU. This report is based on a Measurement Configuration the migrating IAB-MT received from the IAB-donor-CU before.
2. The source parent node IAB-DU sends an UL RRC MESSAGE TRANSFER message to the IAB-donor-CU to convey the received MeasurementReport.
3. The IAB-donor-CU sends a UE CONTEXT SETUP REQUEST message to the target parent node IAB-DU to create the UE context for the migrating IAB-MT and set up one or more bearers. These bearers can be used by the migrating IAB-MT for its own signalling, and, optionally, data traffic.
4. The target parent node IAB-DU responds to the IAB-donor-CU with a UE CONTEXT SETUP RESPONSE message.
5. The IAB-donor-CU sends a UE CONTEXT MODIFICATION REQUEST message to the source parent node IAB-DU, which includes a generated RRCReconfiguration message. The RRCReconfiguration message includes a default BH RLC channel and a default BAP Routing ID configuration for UL F1-C/non-F1 traffic mapping on the target path. It may include additional BH RLC channels. This step may also include allocation of TNL address(es) that is (are) routable via the target IAB-donor-DU. The new TNL address(es) may be included in the RRCReconfiguration message as a replacement for the TNL address(es) that is (are) routable via the source IAB-donor-DU. In case IPsec tunnel mode is used to protect the F1 and non-F1 traffic, the allocated TNL address is outer IP address. The TNL address replacement is not necessary if the source and target paths use the same IAB-donor-DU. The Transmission Action Indicator in the UE CONTEXT MODIFICATION REQUEST message indicates to stop the data transmission to the migrating IAB-node.
6. The source parent node IAB-DU forwards the received RRCReconfiguration message to the migrating IAB-MT.
7. The source parent node IAB-DU responds to the IAB-donor-CU with the UE CONTEXT MODIFICATION RESPONSE message.
8. A Random Access procedure is performed at the target parent node IAB-DU.
9. The migrating IAB-MT responds to the target parent node IAB-DU with an RRCReconfigurationComplete message.
10. The target parent node IAB-DU sends an UL RRC MESSAGE TRANSFER message to the IAB-donor-CU to convey the received RRCReconfigurationComplete message. Also, uplink packets can be sent from the migrating IAB-MT, which are forwarded to the IAB-donor-CU through the target parent node IAB-DU. These UL packets belong to the IAB-MT's own signalling and, optionally, data traffic.
11. The IAB-donor-CU configures BH RLC channels and BAP-sublayer routing entries on the target path between the target parent IAB-node and target IAB-donor-DU as well as DL mappings on the target IAB-donor-DU for the migrating IAB-node's target path. These configurations may be performed at an earlier stage, e.g. immediately after step 3. The IAB-donor-CU may establish additional BH RLC channels to the migrating IAB-MT via RRC message.
12. The F1-C connections are switched to use the migrating IAB-node's new TNL address(es), IAB-donor-CU updates the UL BH information associated to each GTP-tunnel to migrating IAB-node. This step may also update UL FTEID and DL FTEID associated to each GTP-tunnel. All F1-U tunnels are switched to use the migrating IAB-node's new TNL address(es). This step may use non-UE associated signalling in E1 and/or F1 interface to provide updated UP configuration for F1-U tunnels of multiple connected UEs or child IAB-MTs. The IAB-donor-CU may also update the UL BH information associated with non-UP traffic. Implementation must ensure the avoidance of potential race conditions, i.e. no conflicting configurations are concurrently performed using UE-associated and non-UE-associated procedures.
13. The IAB-donor-CU sends a UE CONTEXT RELEASE COMMAND message to the source parent node IAB-DU.
14. The source parent node IAB-DU releases the migrating IAB-MT's context and responds to the IAB-donor-CU with a UE CONTEXT RELEASE COMPLETE message.
15. The IAB-donor-CU releases BH RLC channels and BAP-sublayer routing entries on the source path between source parent IAB-node and source IAB-donor-DU.
   NOTE: In case that the source path and target path have common nodes, the BH RLC channels and BAP-sublayer routing entries of those nodes may not need to be released in Step 15.
   Steps 11, 12 and 15 should also be performed for the migrating IAB-node's descendant nodes, as follows:

The IAB-donor-CU may allocate new TNL address(es) that is (are) routable via the target IAB-donor-DU to the descendent nodes via RRCReconfiguration message.

If needed, the IAB-donor-CU may also provide a new default UL mapping which includes a default BH RLC channel and a default BAP Routing ID for UL F1-C/non-F1 traffic on the target path, to the descendant nodes via RRCReconfiguration message.

If needed, the IAB-donor-CU configures BH RLC channels, BAP-sublayer routing entries on the target path for the descendant nodes and the BH RLC channel mappings on the descendant nodes in the same manner as described for the migrating IAB-node in step 11.

The descendant nodes switch their F1-C connections and F1-U tunnels to new TNL addresses that are anchored at the new IAB-donor-DU, in the same manner as described for the migrating IAB-node in step 12.

Based on implementation, these steps can be performed after or in parallel with the handover of the migrating IAB-node.

NOTE: In upstream direction, in-flight packets between the source parent node and the IAB-donor-CU can be delivered even after the target path is established.

NOTE: In-flight downlink data in the source path may be discarded, up to implementation via the NR user plane protocol (TS 38.425 [24]).

NOTE: The IAB-donor-CU can determine the unsuccessfully transmitted downlink data over the backhaul link by implementation.

### Inter-CU Migration in Rel-17.

As mentioned above, 3GPP Rel-16 has standardized only intra-CU topology adaptation procedure. Considering that inter-CU migration will be an important feature of IAB Rel-17 work item (WI), enhancements to existing procedure are required for reducing service interruption, due to IAB-node migration, and signalling load.

The use cases for inter-donor topology adaptation, also known as inter-CU migration, are:
Inter-donor load balancing. One possible scenario is that a link between an IAB node and its parent becomes congested. In this case, the traffic of an entire network branch, below and including the said IAB node, herein also referred to as the top-level/AB node, may be redirected to reach the top-level node via another route. If the new route for the offloaded traffic includes traversing the network under another donor before reaching the top-level node, the scenario is an inter-donor routing one. The offloaded traffic may include both the traffic terminated at the top-level IAB node and its served UEs, or the traffic traversing the top-level IAB node, and terminated at its descendant IAB nodes and UEs. In this case, the MT of the top-level IAB node, i.e., top-level IAB-MT, may establish an RRC connection to another donor, thus releasing its RRC connection to the old donor, and the traffic towards this node and its descendant devices is now sent via the new donor.
Inter-donor RLF recovery, where an IAB node experiencing an RLF on its parent link attempts RRC reestablishment towards a new parent under another donor, this node can also be referred to as the top-level IAB node. According to 3GPP agreements, if the descendant IAB nodes and UEs of the top-level node “follow” to the new donor, the parent-child relations are retained after the top-level node connects to another donor.

The above cases assume that the top-level node's IAB-MT can connect to only one donor at a time. However, Rel17 work will also consider the case where the top-level IAB-MT can simultaneously connect to two donors, in which case:
For load balancing, the traffic reaching the top-level IAB node via one leg may be offloaded to reach the top-level IAB node, and, potentially, its descendant nodes, via the other leg that the node established to another donor.
For RLF recovery, the traffic reaching the top-level IAB node via the broken leg can be redirected to reach the node via the “good” leg, towards the other donor. With respect to inter-donor topology adaptation, the 3GPP Rel17 specifications will allow two alternatives:
Proxy-based solution—assuming that the top-level IAB-MT is capable of connecting to only one donor at a time, the top-level IAB-MT migrates to a new donor, while the F1 and RRC connections of its collocated IAB-DU and all the descendant IAB-MTs, IAB-DUs and UEs remain anchored at the old donor.
   Proxy-based solution is also applicable in case when the top-level IAB-MT is simultaneously connected to two donors. In this case, some or all of the traffic traversing/terminating at the top-level node is offloaded via the leg towards the ‘other’ donor.
Full migration-based solution, where all the F1 and RRC connections of the top-level node and all its descendant devices and UEs are migrated to the new donor.

Details and an example of proxy-based solution for inter-CU migration:

One drawback of the full migration-based solution for inter-CU migration is that a new F1 connection is set up from IAB-node E to the new CU, i.e., CU (2), and the old F1 connection to the old CU, i.e., CU (1), is released.

Releasing and relocating the F1 connection will impact all UEs, i.e., UE_{c}, UE_{d}, and UEₑ, and any descendant IAB nodes, and their served UEs, by causing:
1. service interruption for the UEs and IAB nodes served by the top-level IAB node, i.e., IAB-node E, since these UEs may need to re-establish their connection or to perform handover operation, even if they remain under the same IAB node, as 3GPP security principles mandate to perform key refresh whenever the serving CU/gNB is changed, e.g., at handover or reestablishment, i.e., RRC reconfiguration with reconfigurationWithSync has to be sent to each UE.
2. a signaling storm, since a large number of UEs, IAB-MTs and IAB-DUs have to perform re-establishment or handover at the same time.

In addition, it is preferred that any reconfiguration of the descendant nodes of the top-level node, herein, the term top-level node is also used, is avoided. This means that the descendant nodes should preferably be unaware of the fact that the traffic is proxied via CU2.

To address the above problems, a proxy-based mechanism has been proposed where the inter-CU migration is done without handing over the UEs or IAB nodes directly or indirectly being served by the top-level IAB node, thereby making the handover of the directly and indirectly served UEs transparent to the target CU. In particular, only the RRC connection of the top-level IAB node is migrated to the target CU, while the CU-side termination of its F1 connection as well as the CU-side terminations of the F1 and RRC connections of its directly and indirectly served IAB nodes and UEs are kept at the source CU—in this case, the target CU serves as the proxy for these F1 and RRC connections that are kept at the source CU. Hence in this case, the target CU just needs to ensure that the ancestor node of the top-level IAB node are properly configured to handle the traffic from the top-level node to the target donor, and from the target donor to the top-level node. Meanwhile, the configuration of the descendant IAB node of the said top-level node are still under the control of the source donor. Hence, in this case the target donor does not need to know the network topology and the QoS requirements or the configuration of the descendant IAB nodes and UEs.

FIG. 7 illustrates the signalling connections when the F1 connections are maintained in the CU-1, while FIG. 8 highlights how the F1-U is tunnelled over the Xn and then transparently forwarded to the IAB donor-DU-2 after the IAB node is migrated to the target donor CU, i.e., CU-2.

FIG. 9 shows an example of inter-donor load balancing scenario, involving IAB3 and its descendant node IAB4 and the UEs that these two IAB nodes are serving.

Applied to the scenario from FIG. 9, the proxy-based solution works as follows:
IAB3-MT changes its RRC connection, i.e., association, from CU_1 to CU_2.
Meanwhile, the RRC connections of IAB4-MT and all the UEs served by IAB3 and IAB4, as well as the F1 connections of IAB3-DU and IAB4-DU would remain anchored at CU_1, i.e., they are not moved to CU_2, whereas the corresponding traffic of these connections is sent to and from the IAB3/IAB4 and their served UEs by using a path via CU_2.

So, the traffic previously sent from the source donor, i.e., CU_1 in FIG. 9, to the top-level IAB node (IAB3) and its descendants, e.g., IAB4, is offloaded, i.e., proxied, via CU_2. In particular:
The old traffic path from CU_1 to IAB4, i.e., CU_1—Donor DU_1—IAB2—IAB3—IAB4 is, for load balancing purposes, changed to CU_1—Donor DU_2—IAB5—IAB3—IAB4.

Herein, the assumption is that direct routing between CU_1 and Donor DU_2 is applied, i.e., CU_1—Donor DU_1—and so on . . . , rather than the indirect routing case CU_1—CU_2—Donor DU_1—and so on . . . The direct routing can e.g. be supported via IP routing between (source donor) CU_1 and donor DU2 (target donor DU) or via an Xn connection between the two. In indirect routing, data can be sent between CU_1 and CU_2 via Xn interface, and between CU_2 and Donor DU_2 via F1 or via IP routing. Both direct and indirect routing are applicable herein. The advantage of direct routing is that the latency is likely to be smaller.

According to TS 38.473 v. 16.4.0, the legacy UE context management messages are used to manage BH RLC channels, enhanced with IAB-specific IEs: UE CONTEXT SETUP REQUEST, UE CONTEXT SETUP RESPONSE, UE CONTEXT MODIFICATION REQUEST, UE CONTEXT MODIFICATION RESPONSE, UE CONTEXT MODIFICATION REQUIRED.

These messages are specified in, e.g., chapter 9.2.2 of TS 38.473 v. 16.4.0 are used to setup, modify and release the BH RLC channels as well, where the ‘UE’ in this case is a child IAB-MT of the DU to which/from which the UE context management message is sent. Below is an excerpt from the UE CONTEXT SETUP REQUEST message from TS 38.473 v. 16.4.0.

Italic marked IEs pertain to the user plane BH RLC channels, reusing the legacy QoS IEs, originally defined for DRB management via UE context management messages.

Meanwhile, the italic marked Control Plane Traffic Type IE indicates the priority of a control plane BH RLC channel, where 1 has the highest priority.

| | | | | | | |
|---|---|---|---|---|---|---|
| BH RLC Channel to | | 0 . . . 1 | | | YES | reject |
| be Setup List | | | | | | |
| >BH RLC Channel | | 1 . . . | | | EACH | reject |
| to be Setup Item | | <maxnoofBHRLCChan- | | | | |
| IEs | | nels> | | | | |
| >>BH RLC CH ID | M | | 9.3.1.113 | | — | |
| >>CHOICE BH | M | | | | | |
| QoS Information | | | | | | |
| >>>BH RLC CH | M | | QoS | Shall be used | | |
| QoS | | | Flow Level | for SA case. | | |
| | | | QoS | | | |
| | | | Parameters | | | |
| | | | 9.3.1.45 | | | |
| >>>E-UTRAN BH | M | | E-UTRAN | Shall be used | | |
| RLC CH QoS | | | QoS | for EN-DC | | |
| | | | 9.3.1.19 | case. | | |
| >>>Control Plane | M | | 9.3.1.115 | | | |
| Traffic Type | | | | | | |
| >>RLC Mode | M | | 9.3.1.27 | | — | |
| >>BAP Control | O | | ENUME | | — | |
| PDU Channel | | | RATED | | | |
| | | | (true, . . .) | | | |
| >>Traffic Mapping | O | | 9.3.1.95 | | — | |
| Information | | | | | | |

### SUMMARY

In inter-donor topology adaptation, it may happen that the number of hops between the top-level node and the, new, donor is different than the number of hops between the top-level node and the, old, donor, i.e., prior to migration. This means that a DRB of a UE served by the top-level IAB node, or its descendant may need to traverse a different number of subsequent BH RLC channels on the old path and the new path, before reaching the node serving the UE.

For example, let us consider the inter-CU scenario depicted in FIG. 10, where an ingress, for DL, and egress, for UL, BH RLC channel (marked UL) configured to an IAB node, e.g., IAB3, is moved from CU_1 to CU_2, e.g., for load balancing purposes. In the scenario depicted, the network topology under the CU_2 is different from the topology under CU_1, and this may affect the performance of the migrating, i.e., top-level, IAB node, in terms of serving its UEs and descendant devices. In fact, in CU_1 the IAB3 is three hops away from the donor DU_1, while in CU_2 it is four hops away from the donor DU_2. Such different topology conditions may affect the QoS of the traffic conveyed by the BH RLC channel(s) that the IAB3 was previously serving under the CU_1. Obviously, the same issue will be experienced by the descendant IAB nodes, i.e., IAB4 and IAB5, and all the UEs served by the concerned IAB3 and by its descendants.

In current specification, for non-IAB networks, when a UE is handed over from a source CU to a target CU, the CU_1 indicates to CU_2 the QoS requirements of the DRBs currently configured to the UEs, e.g., the packet delay budget (PDB), the packet error rate, the bit rate requirements, etc. However, in that case, the UE will still be one hop away from the serving RAN node, e.g., DU/CU or gNB. On the other hand, in an IAB network, just providing, to the target CU, the PDB requirement of the individual ingress/egress BH RLC channel(s) that is (are) migrated to the target CU will not be enough to meet the PDB requirements of the bearers carried by these BH RLC channels, since the PDB requirement(s) of such channel(s) is (are) also dependent on the PDB requirements at the ancestor nodes, for DL traffic, and descendant nodes, for UL traffic. For example, for DL traffic, the PDB of a BH RLC channel between the top-level node and its parent depends on the number of wireless hops and properties of the corresponding subsequent BH RLC channels between the donor and the parent. If the distance, in hops, between the old parent of the top-level node and its donor and the new parent and its donor is different, the PDB pertaining to a BH RLC channel serving the top-level node under the old donor may not be applicable anymore, when this channel is migrated to the new donor.

An object herein is to provide a mechanism to enable communication, e.g., handle or manage communication, in an efficient manner in a wireless communications network.

According to an aspect the object is achieved, according to embodiments herein, by providing a method performed by a first radio network node, such as an IAB donor node, for handling communication in the wireless communications network, for example, handling migration of a second network node, or parts of its traffic, to a second radio network node. The first radio network node transmits an indication to the second radio network node, indicating an obtained delay information for one or more channels associated with the second network node that is conveying traffic that will be transmitted via the second radio network node, wherein the delay information indicates a delay between at least a plurality of network nodes. The first radio network node further receives a response from the second radio network node, indicating confirmation or rejection to be able to meet a requirement of delay as indicated by said transmitted indication. The first radio network node may obtain the delay information such as cumulative packet delay budget, for one or more channels associated with the second network node that is conveying traffic that will be transmitted via the second radio network node, wherein the delay information indicates a delay (a cumulative delay) between at least a plurality of network nodes, for example, over at least two hops related to the second network node.

According to another aspect the object is achieved, according to embodiments herein, by providing a method performed by a second radio network node such as an IAB donor node, handling communication in the wireless communications network, for example, handling migration of a second network node, or parts of its traffic, to the second radio network node. The second radio network node receives an indication from a first radio network node, indicating delay information for one or more channels associated with the second network node that is conveying traffic that will be transmitted via the second radio network node, wherein the delay information indicates a delay (a cumulative delay) between at least a plurality of network nodes, e.g., over at least two hops related to the second network node. The second radio network node determines whether the indicated delay information can be sustained (met) by network nodes associated with the second radio network node. The second radio network node transmits a response to the first radio network node confirming or rejecting to be able to meet a requirement of delay as indicated by said received indication based on the determination.

According to yet another aspect the object is achieved, according to embodiments herein, by providing a first radio network node and a second radio network node configured to perform the methods herein, respectively.

Thus, according to an aspect the object is achieved, according to embodiments herein, by providing a first radio network node for handling communication in the wireless communications network. The first radio network node is configured to transmit an indication to a second radio network node, indicating an obtained delay information for one or more channels associated with a second network node that is conveying traffic that will be transmitted via the second radio network node, wherein the delay information indicates a delay between at least a plurality of network nodes. The first radio network node is further configured to receive a response from the second radio network node, indicating confirmation or rejection to be able to meet a requirement of delay as indicated by said transmitted indication.

According to another aspect the object is achieved, according to embodiments herein, by providing a second radio network node such as an IAB donor node, handling communication in the wireless communications network. The second network node is configured to receive an indication from a first radio network node, indicating delay information for one or more channels associated with the second network node that is conveying traffic that will be transmitted via the second radio network node, wherein the delay information indicates a delay (a cumulative delay) between at least a plurality of network nodes. The second radio network node is further configured to determine whether the indicated delay information can be sustained (met) by network nodes associated with the second radio network node. The second radio network node is configured to then transmit a response to the first radio network node confirming or rejecting to be able to meet a requirement of delay as indicated by said received indication based on the determination.

It is furthermore provided herein a computer program product comprising instructions, which, when executed on at least one processor, cause the at least one processor to carry out the methods herein, as performed by the first radio network node, and the second radio network node, respectively. It is additionally provided herein a computer-readable storage medium, having stored thereon a computer program product comprising instructions which, when executed on at least one processor, cause the at least one processor to carry out the methods herein, as performed by the first radio network node, and the radio second network node, respectively.

Embodiments herein provide methods to exchange delay information such as packet delay budget information between the first radio network node controlling, for example, a certain IAB node, i.e., which may have an established F1 and/or RRC connection with the source CU, and the second radio network node to which said IAB node or parts of its traffic is going to be migrated, and wherein said exchanged packet delay budget information may be associated to traffic of one or more ingress and/or egress BH RLC channels configured to said IAB node by the first radio network node and that is going to be migrated to the second radio network node. It is herein also disclosed methods to configure the packet delay budgets (PDB) to the IAB nodes in the second radio network node that are serving directly or indirectly traffic traversing the migrating IAB node, wherein the configuration of such PDBs is based on an exchanged latency requirement.

The latency requirement of one or more BH RLC channels may still be fulfilled when they are migrated to the second radio network node, regardless of the potential differences in network topology under the radio network node, i.e., there is no performance degradation latency-wise for such BH RLC channels. Thus, embodiments herein enable a reliable communication, e.g. handle or manage signalling/communication in an efficient manner in a wireless communications network.

### BRIEF DESCRIPTION OF THE DRAWINGS

Embodiments will now be described in more detail in relation to the enclosed drawings, in which:

FIG. 1 shows a Reference diagram for IAB-architectures (TR 38.874 v.16.6.0);

FIG. 2 shows protocol stacks according to prior art;

FIG. 3 shows protocol stacks according to prior art;

FIG. 4 shows an example of functional view of BAP sublayer according to prior art;

FIG. 5 shows examples of different possible scenarios for IAB topology adaptation;

FIG. 6 shows an IAB intra-CU topology adaptation procedure;

FIG. 7 shows an example of signal flow before IAB-node 3 migration;

FIG. 8 shows an example of signal flow after IAB-node 3 migration;

FIG. 9 shows an example of inter-donor load balancing scenario, involving IAB3 and its descendant node IAB4 and the UEs that these two IAB nodes are serving;

FIG. 10 shows an example of inter-CU migration for a BH RLC channel;

FIG. 11 shows an overview depicting a wireless communications network according to embodiments herein;

FIG. 12a shows a flowchart depicting a method performed by a first radio network node according to embodiments herein;

FIG. 12b shows a flowchart depicting a method performed by a second radio network node according to embodiments herein;

FIG. 13 shows an overview depicting cumulative packet delay budget computation from/to the donor to/from the top-level-level IAB node for a migrating BH RLC channel;

FIG. 14 shows an overview depicting cumulative packet delay budget computation from/to the donor to/from the top-level-level IAB node for a migrating BH RLC in the case of ancestor node with multi parents;

FIG. 15 shows an overview depicting cumulative packet delay budget computation from/to the concerned top-level IAB node to/from the IAB access node for a migrating BH RLC channel;

FIG. 16 shows a block diagram depicting embodiments of a first radio network node according to embodiments herein;

FIG. 17 shows a block diagram depicting embodiments of a second radio network node according to embodiments herein;

FIG. 18 schematically illustrates a telecommunication network connected via an intermediate network to a host computer;

FIG. 19 is a generalized block diagram of a host computer communicating via a base station with a user equipment over a partially wireless connection; and

FIGS. 20-23 are flowcharts illustrating methods implemented in a communication system including a host computer, a base station and a user equipment.

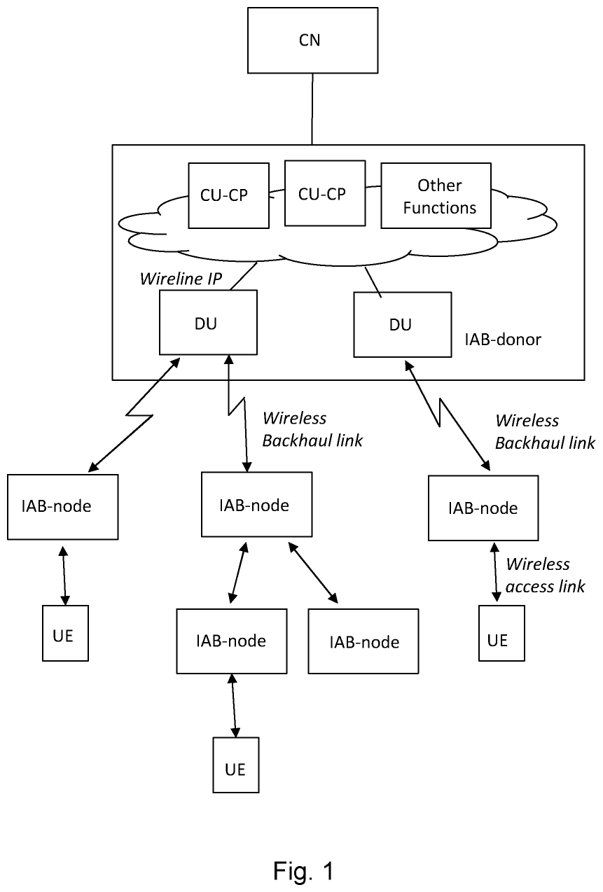

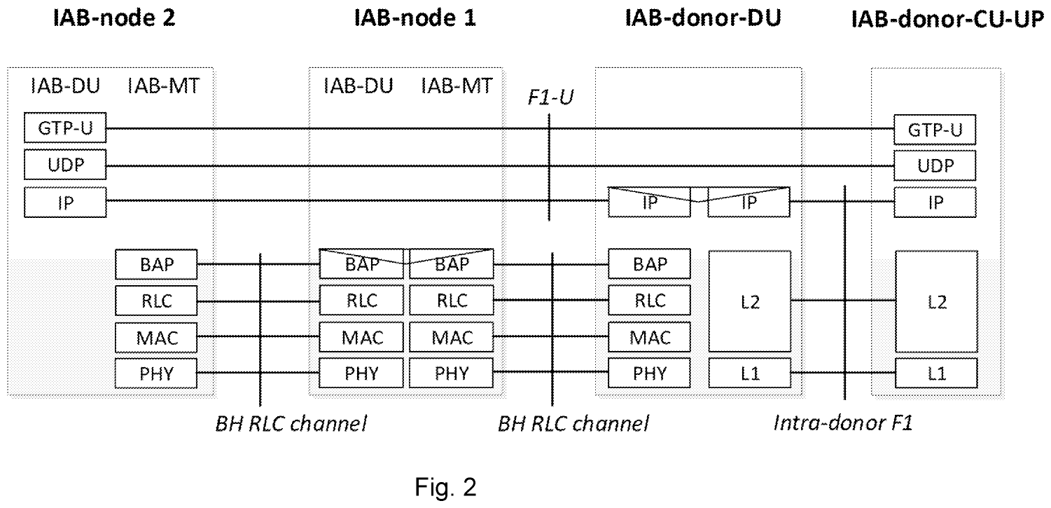

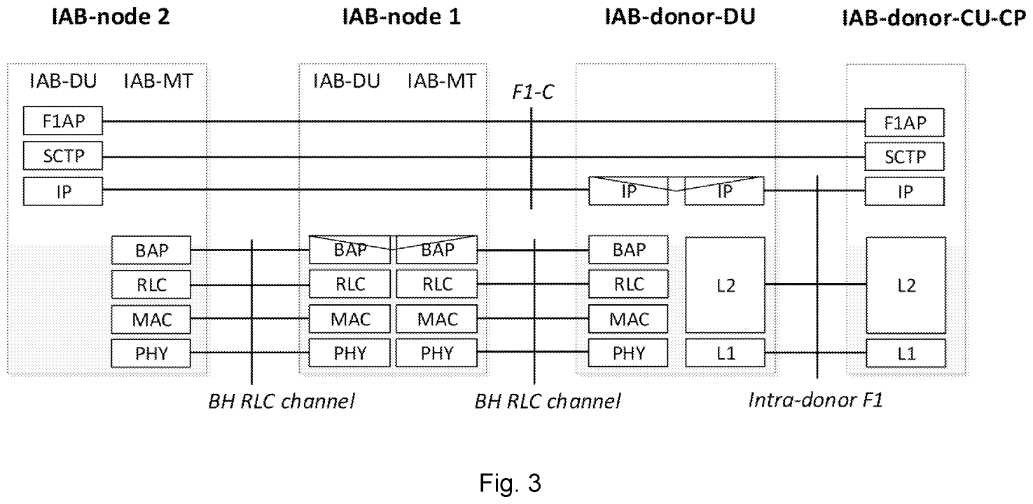

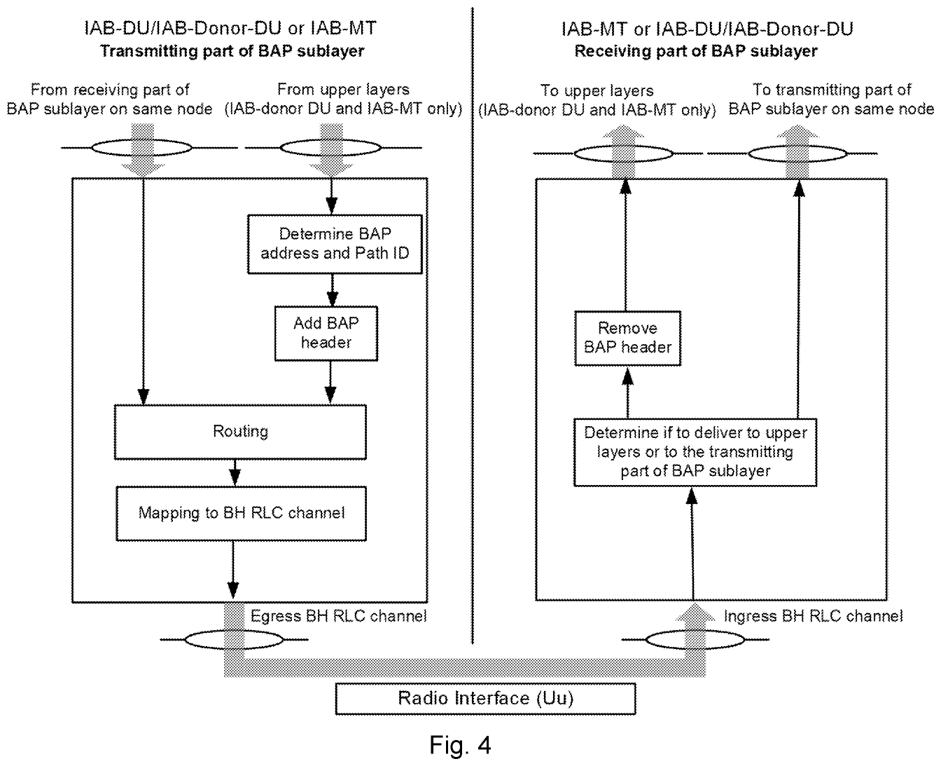

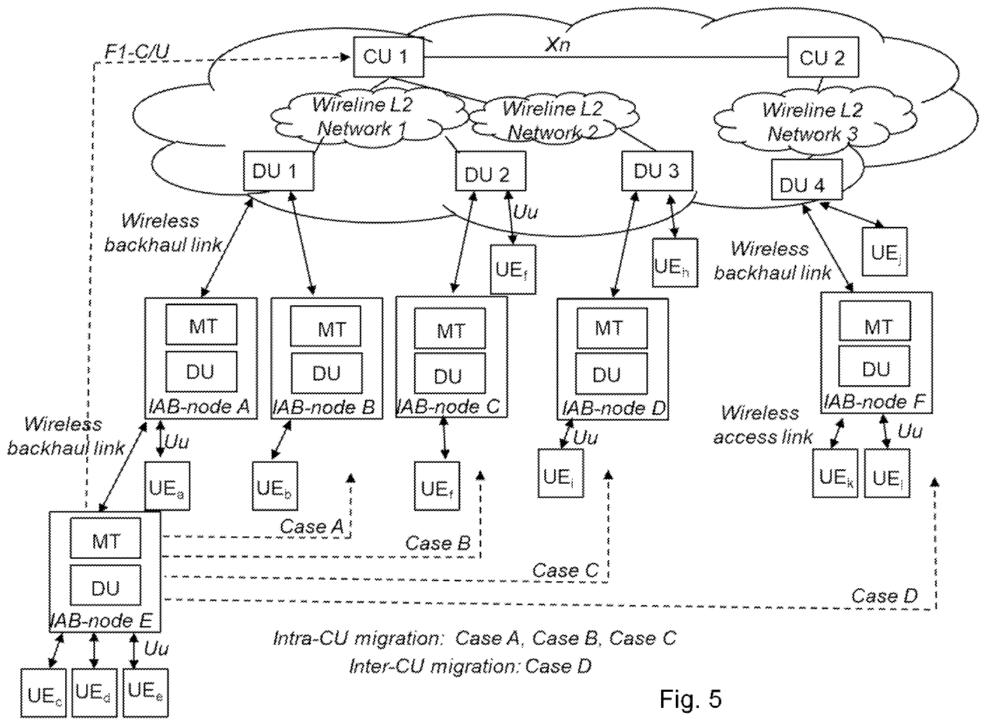

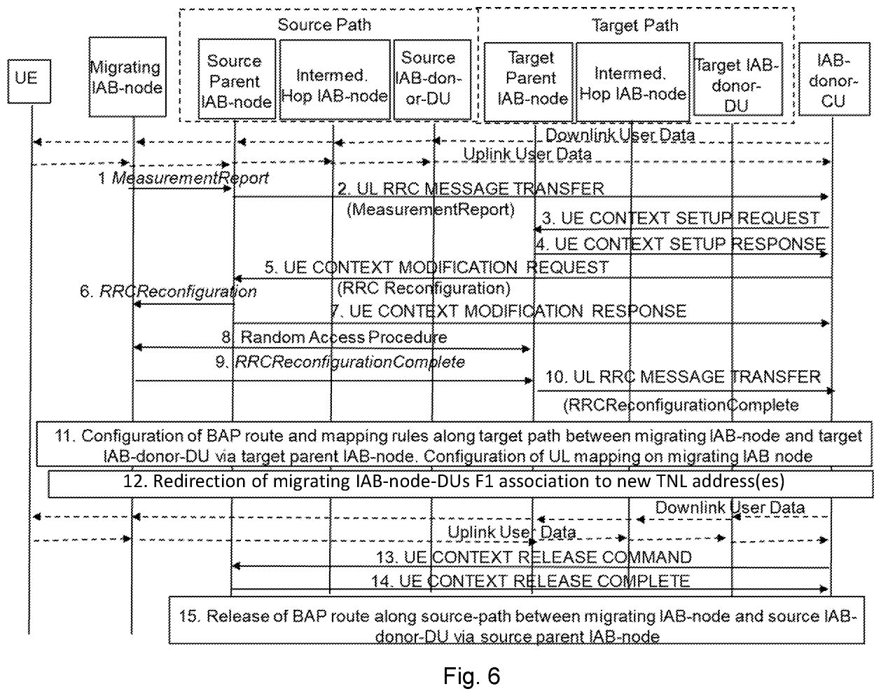

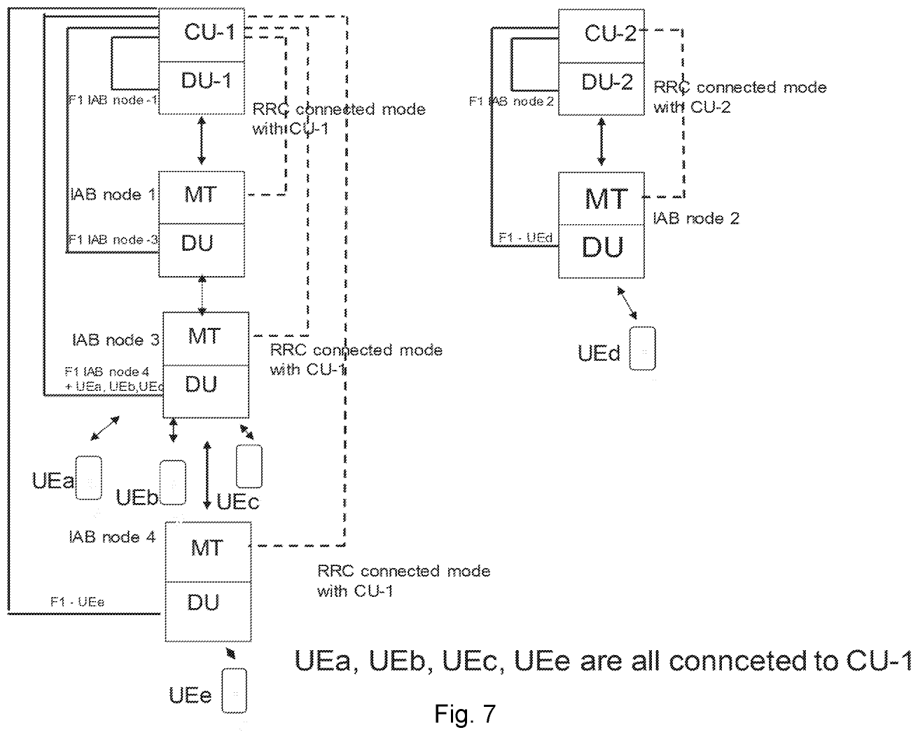

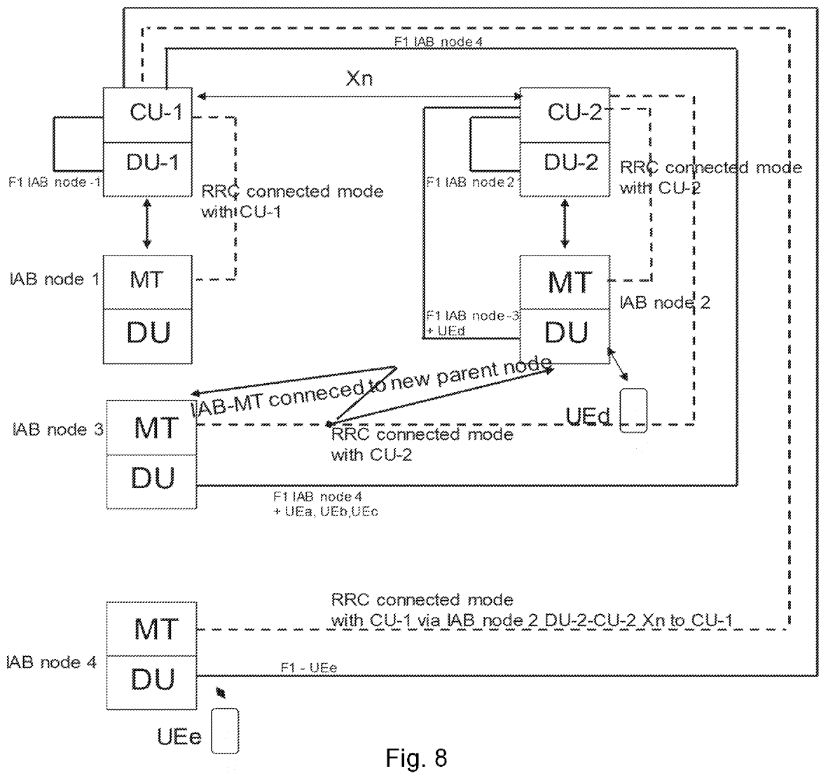

### DETAILED DESCRIPTION

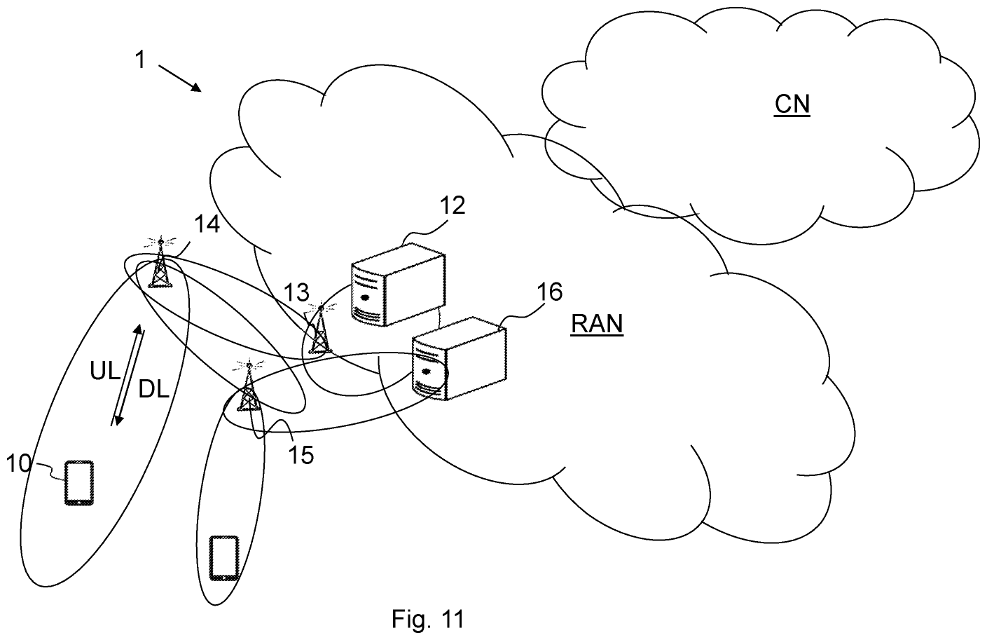

Embodiments herein relate to wireless communications networks in general. FIG. 11 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the wireless communications network 1, a user equipment (UE) 10 such as a mobile station, a wireless device, a non-access point (non-AP) STA, a STA, and/or a wireless terminal, is comprised communicating via e.g. one or more Access Networks (AN), e.g. RAN, to one or more core networks (CN). It should be understood by the skilled in the art that “UE” is a non-limiting term which means any terminal, wireless communications terminal, user equipment, Internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a first radio network node 12 e.g. an IAB node such as an IAB-donor node or an IAB-CU, baseband unit (BBU), an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), MME, AMF, a stand-alone access point or any other network unit or node capable of communicating with a UE within a service area served by the radio network node depending e.g. on a first radio access technology and terminology used. The first radio network node 12 may also be referred to as serving or source node or RAN node. It should be noted that a service area may be denoted as cell, beam, beam group or similar to define an area of radio coverage.

The wireless communications network 1 further comprises a first intermediate radio network node 13 connected in-between the first radio network node 12 and the UE 10. The first intermediate radio network node 13 may be an IAB node such as an IAB-DU e.g. a radio remote unit (RRU), an access node, antenna unit, radio unit of e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within a service area served by the radio network node depending e.g. on a first radio access technology and terminology used.

The wireless communications network further comprises a second intermediate radio network node, being an example of a first network node 14 according to embodiments herein, connected in-between the first radio network node 12 and the UE 10. The first network node 14 may be connected to the UE 10 directly and may be an egress/ingress point. The first network node 14 may be an IAB node e.g. a radio remote unit (RRU), an access node, antenna unit, radio unit of e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within a service area served by the radio network node depending e.g. on a radio access technology and terminology used. It should be noted that a service area may be denoted as cell, beam, beam group or similar to define an area of radio coverage.

The wireless communications network 1 may further comprise a third intermediate radio network node, being an example of a second network node 15, connected to the first network node 14, other network nodes, and/or to served UEs. The second network node 15 may be an IAB node e.g. a radio remote unit (RRU) such as an access node, antenna unit, radio unit of e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within a service area served by the radio network node depending e.g. on a radio access technology and terminology used. It should be noted that a service area may be denoted as cell, beam, beam group or similar to define an area of radio coverage.

The wireless communications network 1 may further comprise a second radio network node 16 being an IAB node such as an IAB-donor node or an IAB-CU, baseband unit (BBU), an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), MME, AMF, a stand-alone access point or any other network unit or node capable of communicating with a UE within a service area served by the radio network node depending e.g. on a first radio access technology and terminology used. The second radio network node 12 may also be referred to as target node or RAN node.

Embodiments herein relate to a scenario where a IAB node, being an example of the first radio network node 12, such as a serving central unit or CU, may determine initiation for topology adaptation, such as determine a congestion or initiates a load balancing between central units. The first radio network node 12 may migrate a IAB node, being an example of the second network node 15, or traffic related to it, to the second radio network node 16 and according to embodiments herein methods are herein provided to exchange, for example, PDB information between the first radio network node controlling the migrating IAB node, i.e., which has an established F1 and/or RRC connection with the first radio network node 12, and the second radio network node 16 to which the migrating IAB node or parts of its traffic is going to be migrated, and wherein said exchanged PDB information may be associated with the one or more ingress/egress BH RLC channels configured to the migrating IAB node by the first radio network node 12 and that are going to be migrated to the second radio network node 16.

Embodiments herein may comprise one or more of the following actions:
1. Methods for a source CU, being an example of the first radio network node 12, to indicate to a target CU, being an example of the second radio network node 16, delay information such as a cumulative PDB configured by the source CU to the ancestor, or descendant, IAB nodes that are serving traffic, in their respective BH RLC channels, that is conveyed to a concerned, i.e., top-level, IAB node in an ingress and/or egress BH RLC channel that is migrated to the target CU.
2. Methods for the target CU, being an example of the second radio network node 16, to configure the PDB to the IAB nodes, controlled by the target CU, that are serving traffic, in their respective BH RLC channels, that is conveyed in the new ingress and/or egress BH RLC channel(s) configured to the concerned, i.e., top-level, IAB node by the target CU, and wherein such PDB reconfiguration is based on the cumulative PDB received in the action above.
3. Methods for the target CU, being an example of the second radio network node 16, to determine and indicate to the source CU, being an example of the first radio network node 12, whether the cumulative PDB in the action 1 above can be guaranteed in the target CU, and, if it cannot be guaranteed, methods to determine and indicate to the source CU the PDB that can be guaranteed.
4. (Optionally for a Proxy-based inter-CU migration) Methods for the source CU, being an example of the first radio network node 12, to reconfigure the PDB of the IAB nodes, controlled by the source CU, that are serving traffic, in their respective BH RLC channels, that is conveyed in the new ingress/egress BH RLC channel(s) configured to the concerned, i.e., top-level, IAB node by the target CU, being an example of the second radio network node 16, and wherein such PDB reconfiguration is based on the cumulative PDB that can be guaranteed by the target CU as indicated by target CU in action 3. The reconfigured IAB nodes are the IAB nodes controlled by the source CU, i.e., the descendant IAB nodes of the migrating, i.e., top-level, IAB node in the proxy-based inter-CU migration.

The latency requirements of one or more BH RLC channels are still fulfilled when the one or more BH RLC channels are migrated to the target CU, regardless of the potential differences in network topology under the source and target CU, i.e., there is no performance degradation latency-wise for such BH RLC channels.

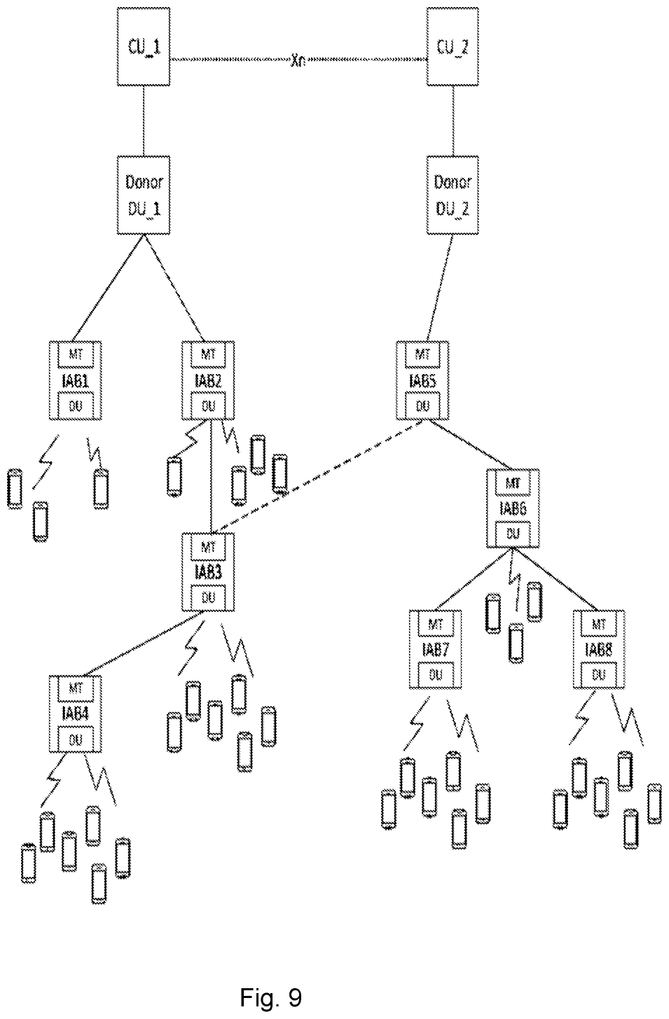

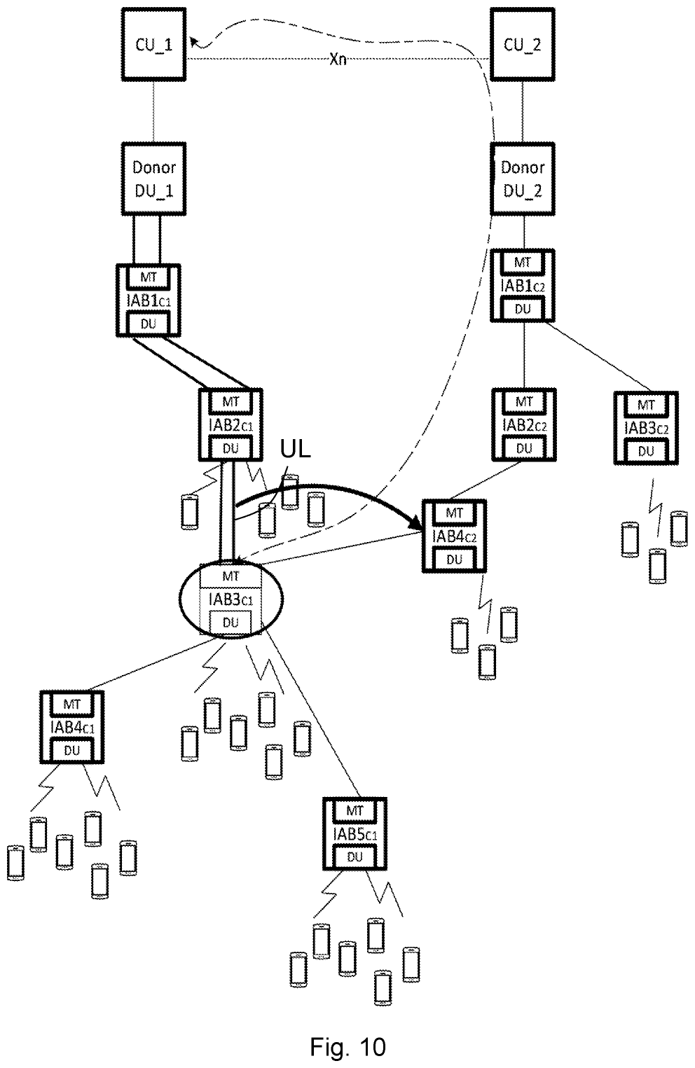

It should be noted that:
The terms “gNB-CU” and “Donor-CU”, and “CU” are used interchangeably.
The term “gNB” applies to all variants therein, e.g. “gNB”, “en-gNB” etc.
The term “IAB donor” refers to a gNB that provides network access to UEs via a network of backhaul and access links.
The term “Intermediate IAB node” refers to an IAB node with one or more ingress BH RLC channels and one or more egress BH RLC channels
The term “IAB Access node” refers to an IAB node that provides an access link to UEs for a certain BAP PDU.
The term “IAB node” refers to any of “IAB donor”, “Intermediate IAB node”, “IAB Access node”.
The term “descendant node” may refer to both the child node and the child of the child and so on.
The term “ancestor node” may refer to both the parent node and the parent of the parent and so on including the donor node.
The terms “traffic offloading” and “load balancing” are used interchangeably.
The terms “CU_1”, “source donor” and “old donor” are used interchangeably.
The terms “CU_2”, “target donor” and “new donor” are used interchangeably.
The terms “Donor DU_1”, “source donor DU” and “old donor DU” are used interchangeably.
The terms “Donor DU_2”, “target donor DU” and “new donor DU” are used interchangeably.
Embodiments herein apply to both the proxy-based alternative and the full migration-based alternative, described above.
The terms “migrating IAB node” and “top-level IAB node” are used interchangeably, and they may refer to: 1) in case of proxy-based alternative described above, to the IAB-MT of this node (e.g. IAB3-MT in FIG. 9), because the collocated IAB-DU of the top-level node may not migrate (it maintains the F1 connection to the source donor); 2) in case of full migration-based alternative, they may refer to the entire IAB node.
   In one example, such top-level IAB node may be an IAB, where the traffic carried to/from/via this node, or part of this traffic, is taken over by, i.e., proxied, a target donor, load balancing, i.e., the source donor off-loads the traffic pertaining to certain ingress/egress BH RLC channels between the said IAB node and its parent node to the target donor.
The term “migration” is unambiguously used to represent the scenario in which a top-level/migrating IAB-MT is subject to a migration to the target donor, or the scenario in which the ingress/egress traffic, or a portion of it, e.g., a BH RLC channel, of the top-level/migrating IAB node is off-loaded by the source donor to the target donor, load balancing.
   In one example, the migration may be executed, as a consequence of a handover to the target donor in which case all the ingress/egress BH RLC channels served by the migrating IAB node are moved to the target CU.
   For the load balancing scenario, if only a portion of the ingress/egress traffic is off-loaded to the target donor, the top-level IAB-MT may maintain connectivity with both source and target donor, i.e., a dual protocol stack (DAPS) or dual connectivity (DC) is configured at the top-level IAB-MT to maintain both connections.
Although embodiments herein are presented on the scenario where the top-level IAB-MT is connected only to one donor at a time, it equally applies to the scenarios where the top-level IAB-MT can simultaneously connect to two donors
   The embodiments also apply to the scenario where top-level IAB-MT is served by two gNBs, out of which one is an IAB donor and the other one is a legacy gNB, whereas either of the two serving nodes can be a master or a secondary node for the IAB-MT of the top-level node.
The terms “RRC/F1 connections of descendant devices” refer to the RRC connections of descendant IAB-MTs and UEs with the donor, source donor in this case, and the F1 connections of the top-level IAB-DU and IAB-DUs of descendant IAB nodes of the top-level IAB node.
Traffic between the CU_1 and the top-level IAB node and/or its descendant nodes (also referred to as the proxied traffic) refers to the traffic between the CU_1 and:
   1. the collocated IAB-DU part of the top-level IAB node (since the IAB-MT part of the top-level IAB node has migrated its RRC connection to the new donor),
   2. the descendant IAB nodes of the top-level IAB node, and
   3. the UEs served by the top-level node and its descendant nodes.
In embodiments herein, it is assumed that, both user plane and control plane traffic are sent by means of direct and indirect routing.
The term “destination is IAB-DU”, comprises both the traffic whose final destination is either said IAB-DU or a UE or IAB-MT served by said IAB-DU, and that includes top-level IAB-DU as well.
The term “data” refers to both user plane, control plane traffic and non-F1 traffic.

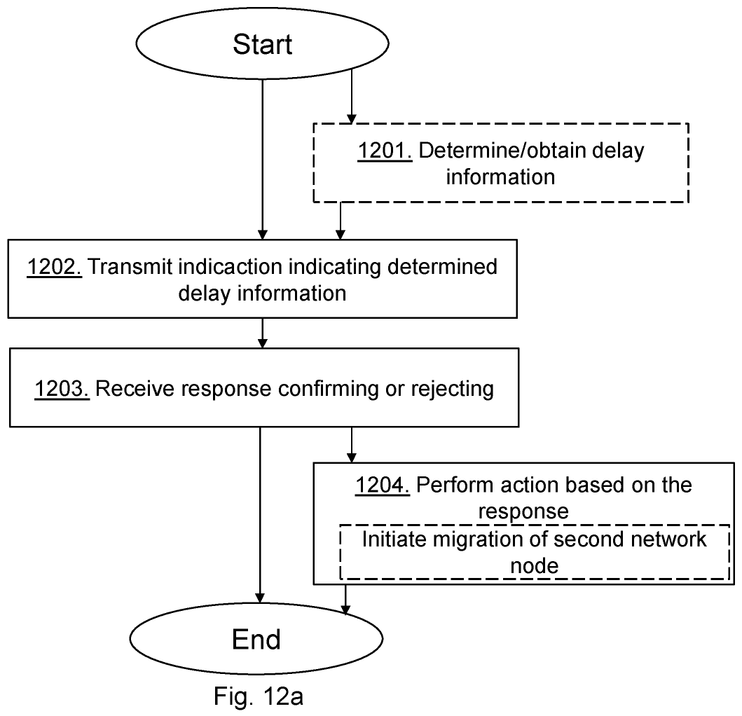

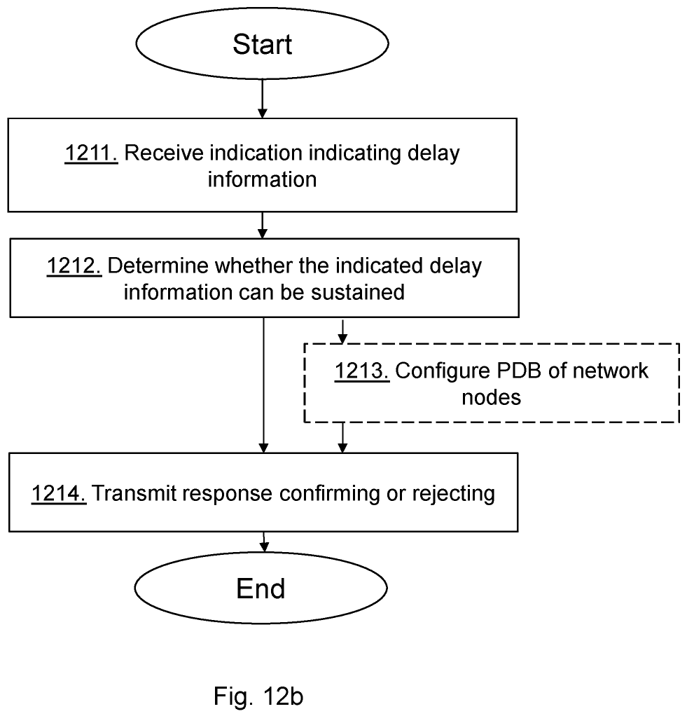

The method actions performed by the first radio network node 12, such as an IAB node, e.g., a first donor node or a first CU, for handling communication in the wireless communications network 1 according to embodiments herein will now be described with reference to a flowchart depicted in FIG. 12a. The actions do not have to be taken in the order stated below, but may be taken in any suitable order. Dashed boxes indicate optional features. The first radio network node 12 may be a first central unit and the second radio network node 16 may be a second central unit.

Action 1201. The first radio network node 12 may obtain a delay information for one or more channels associated with the second network node 15. For example, the first radio network node 12 may determine or obtain (receive or read internally) the delay information such as cumulative packet delay budget, for one or more channels associated with the second network node 15 migrating to the second radio network node 16, wherein the delay information indicates a delay (a cumulative delay) between at least a plurality of network nodes e.g. over at least two hops related to the second network node 15. The second network node 15 may be an IAB node. For example, the first radio network node 12 may perform one or more of the following: determine a cumulative packet delay budget for one or more channels between two or more network nodes for example from/to the first radio network node 12 to/from the second network node 15; determine cumulative packet delay budget for one or more channels from/to the first radio network node to/from the second network node 15; determine cumulative packet delay budget for one or more channels from/to the second network node 15 to/from another network node i.e. cumulative packet delay budget from/to the concerned top-level IAB node to/from the IAB access node associated to such BH RLC channel; and obtain individual PDB configured to the second network node 15, for each individual ingress (for upstream) and egress (for downstream) BH RLC channel configured between the concerned second network node 15 and its descendant IAB nodes; an end-to-end latency requirement of tone or more quality of service flows, conveyed in a migrating BH RLC channel; and a cumulative PDB value computed and indicated per BH RLC channel per BAP destination.

Action 1202. The first radio network node 12 transmits an indication to the second radio network node 16, indicating the obtained delay information for one or more channels associated with the second network node 15 that is conveying traffic that will be transmitted via the second radio network node 16, wherein the delay information indicates a delay between at least a plurality of network nodes. For example, transmitting the indication to the second radio network node 16, indicating the determined delay information, e.g., for one or more (each) BH RLC channel of the second network node 15 that is conveying traffic that will be transmitted via the second radio network node 16. The indication may be a value of the delay information. The inidciation may be referred to as a PDB indication message.

Action 1203. The first radio network node 12 receives a response from the second radio network node 16 indicating confirmation or rejection to be able to meet a requirement of delay as indicated by said transmitted indication. The delay information transmitted may indicate the requirement. The response may indicate possible delay information, such as possible PDB, at the second radio network node 16. Thus, the response may indicate delay that the IAB node will experience if moved to the second radio network node.

Action 1204. The first radio network node 12 may then perform an action based on the response, e.g., operate based on the response. Either initiates migration, or re-determines delay information taking the response into consideration. The first radio network node 12 may initiate a migration of the second network node such as a top level IAB, or parts of its traffic, to the second radio network node 16, or may re-determine a second delay information taking the received response into consideration. For example, the first radio network node 12 may: initiate Inter-CU Load Sharing; identify potential new parent IAB under a different CU: select a (best) CU or Cell to Perform Load Sharing or migration; send the message to new target CU(s) with the resource requirements; obtain the response from CU(s); take different actions as per the response received (ACK/NACK/Cause Codes).

The method actions performed by the second radio network node 16, such as an IAB node e.g., a donor node or a second CU, for handling communication in the wireless communications network 1 according to embodiments herein will now be described with reference to a flowchart depicted in FIG. 12b. The actions do not have to be taken in the order stated below, but may be taken in any suitable order. Dashed boxes indicate optional features. The first radio network node 12 may be a first central unit and the second radio network node 16 may be a second central unit. The second network node 15 may be an IAB node.

Action 1211. The second radio network node 16 receives the indication from the first radio network node 12, indicating the delay information for the one or more channels associated with the second network node 15 that is conveying traffic that will be transmitted via the second radio network node 16, wherein the delay information indicates the delay between at least a plurality of network nodes. The indication may thus indicate the delay information for each BH RLC channel of the second network node 15 that is conveying traffic that will be transmitted via the second radio network node 16. The delay information may comprise one or more of the following: the cumulative packet delay budget for one or more channels from/to the first radio network node 12 to/from the second network node 15; the cumulative packet delay budget for one or more channels from/to the second network node 15 to/from another network node i.e. cumulative packet delay budget from/to the concerned top-level IAB node to/from the IAB access node associated to such BH RLC channel; the individual PDB configured to the second network node 15, for each individual ingress (for upstream) and egress (for downstream) BH RLC channel configured between the concerned second network node 15 and its descendant IAB nodes; an end-to-end latency requirement of tone or more quality of service flows, conveyed in a migrating BH RLC channel; and a cumulative PDB value computed and indicated per BH RLC channel per BAP destination.

Action 1212. The second radio network node 16 determines whether the indicated delay information can be sustained by one or more network nodes associated with the second radio network node 16. The second radio network node 16 may determine a possible PDB of network nodes associated with the second radio network node 16 The second radio network node 16 may thus determine amount of possible PDB of network nodes associated with (served by) the second radio network node 16.

Action 1213. The second radio network node 16 may configure the PDB of network nodes associated with the second radio network node 16. For example, the second radio network node 16 may configure network nodes (for upstream and downstream traffic) and the top-level IAB node (for upstream traffic) such that the cumulative PDB from/to the target donor to/from the top-level-level IAB node matches or it is smaller than the cumulative PDB indicated by the received indication.

Action 1214. The second radio network node 16 then transmits the response to the first radio network node 12 confirming or rejecting to be able to meet a requirement of delay as indicated by said received indication. The transmitted response may indicate the possible PDB at the second radio network node 16. Thus, the response may indicate delay that the IAB node will experience if moved to the second radio network node 16.

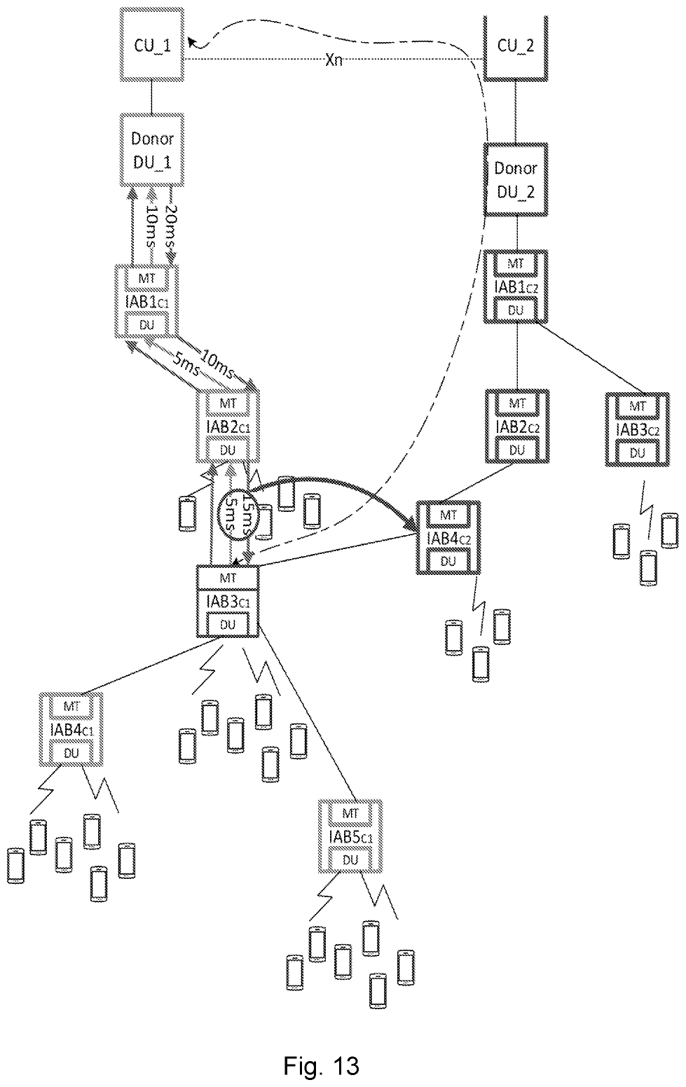

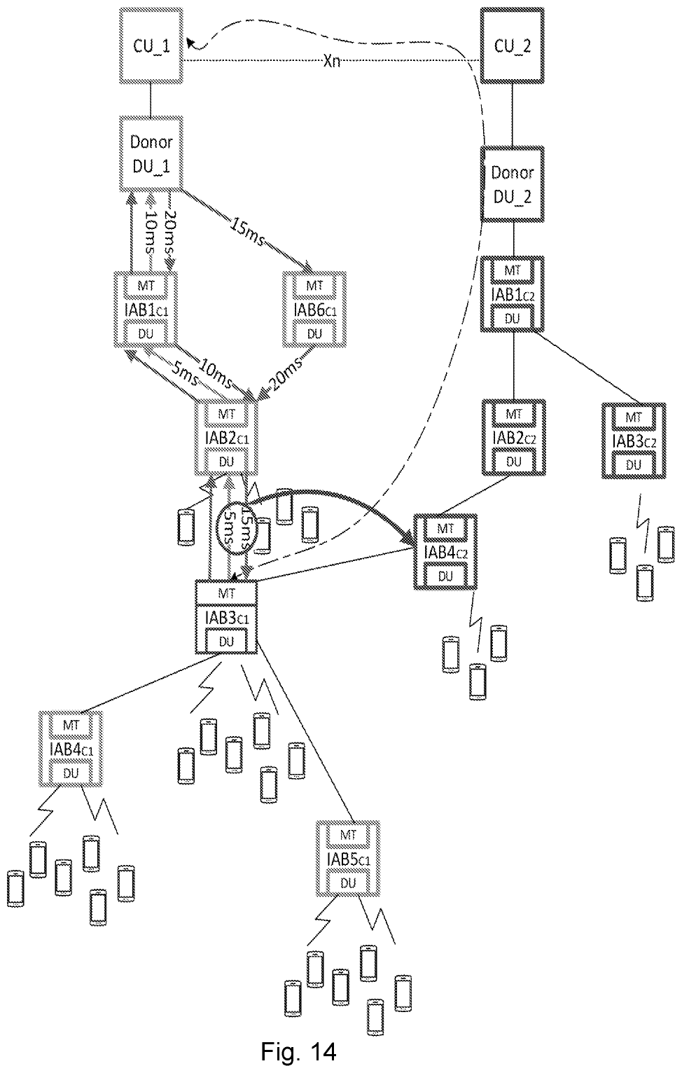

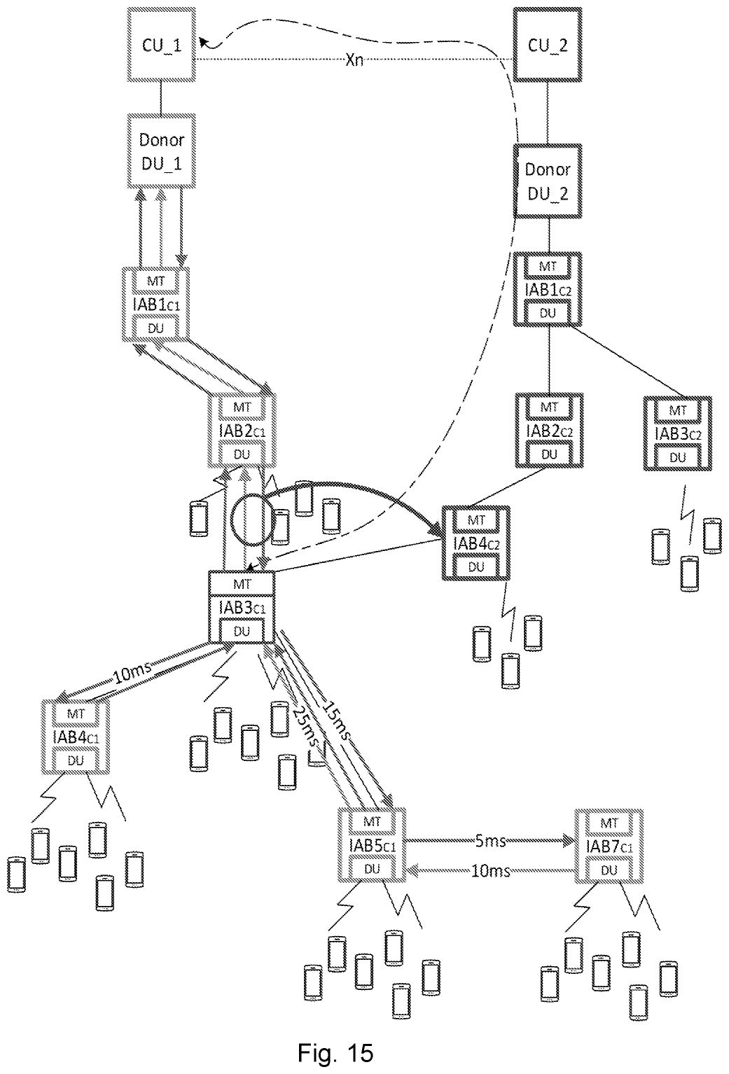

Thus, a donor CU such as the first radio network node 12 (herein referred to as the serving CU, source CU or old CU) performs one or more of the following:
Determining, being an example of action 1201, the following packet-delay budget related information for an ingress, for downstream traffic, or egress, for upstream traffic, BH RLC channel of an IAB node, say top-level IAB node, wherein the BH RLC channel is one of the ingress/egress BH RLC channels configured to this IAB node and that has been selected for migration to the second radio network node 16, say target donor CU, or CU1. In case the whole IAB node is migrated to a target CU, e.g., as consequence of an HO, or upon performing a reestablishment to a cell hosted by a DU controlled by a target CU, e.g. as a consequence of an RLF, all the BH RLC channels configured to this IAB node are migrated to the target CU:
   (1201a): The cumulative packet delay budget from/to the donor to/from the top-level IAB node associated to such BH RLC channel, wherein the said cumulative packet delay budget is:
      For the ingress BH RLC channel of the top-level IAB node, the sum of the packet delay budgets (PDB) configured by the source CU to the ancestor IAB nodes that are serving traffic in the downstream and are conveying this traffic into the said ingress BH RLC channel.
         NOTE: For a BH RLC channel, the Packet Delay Budget defines the upper bound for the time that a packet may be delayed between the IAB-DU and its child IAB-MT.
      For the egress BH RLC channel of the top-level IAB node, the sum of the packet delay budgets (PDBs) configured by the source CU to the concerned IAB node and to the ancestor nodes that are serving traffic in the upstream, whereas this traffic is conveyed to these ancestor nodes in the said egress BH RLC channel.
      Let's consider the example in FIG. 13, where an ingress (marked 15 ms in the circle) and egress (marked 5 ms in the circle) BH RLC channel for a top-level node IAB3 are migrated to a target donor. Focusing on the ingress BH RLC channel, the source donor CU has configured a PDB of:
         15 ms for the ancestor node IAB2 to serve this BH RLC channel,
         of 10 ms for IAB2 when serving a BH RLC channel between IAB1 and IAB2 and that is carrying traffic that will be conveyed by IAB2 into the concerned egress BH RLC channel
         of 20 ms for the donor DU when serving a BH RLC channel between the donor DU and IAB1 that is carrying traffic that will be conveyed by IAB2 into the concerned egress BH RLC channel
         Hence the cumulative packet delay budget for the concerned ingress BH RLC channel is 45 ms. Similarly, the cumulative budget for the egress BH RLC channel of the IAB3 which is migrated to the target CU is 20 ms (5+5+10 ms)
      In another example of this method, it is considered the case in which one of the migrating BH RLC channels conveys traffic that is carried via different paths by the ancestor nodes. In one case, the source CU determines that the cumulative PDB for the concerned BH RLC channel is the cumulative PDB of the path which has the larger cumulative PDB among the various paths that are serving traffic conveyed in the concerned BH RLC channel. In another case, the source CU selects the smaller cumulative PDB, in yet another case the average.
         For example, in FIG. 14, the traffic conveyed in the concerned BH RLC channel, marked 15 ms in the circle, by the parent node IAB2 to the child node IAB3 and that is going to be migrated to the target CU, can be carried via different paths by other BH RLC channels handled by the ancestor nodes. In particular, in the case in FIG. 14, the cumulative PDB for the path DU1-IAB1-IAB2-IAB3 is 20+10+15=45 ms, whereas for the path DU1-IAB6-IAB2 is 15+20+15=50 ms. Hence the source CU determines that the cumulative PDB for the concerned BH RLC channel is 50 ms, in case the CU decides to select the largest PDB among the various paths.
         The same principle may apply to the upstream traffic in case the upstream traffic associate to one egress BH RLC channel is carried via multiple paths
   (1201b): In another method, rather than the “cumulative packet delay budget from/to the donor to/from to the top-level-level IAB node”, the source CU determines for an ingress, for downstream traffic, or egress, for upstream traffic, BH RLC channel of an IAB node, say top-level IAB node, the cumulative packet delay budget from/to the concerned top-level IAB node to/from the IAB access node associated to such BH RLC channel, wherein the said cumulative packet delay budget is:
      For the ingress BH RLC channel, the sum of the PDBs configured by the source CU to the concerned IAB node and to the descendant nodes that are serving traffic in the downstream conveyed in the said egress BH RLC channel,
      For the egress BH RLC channel, the sum of the PDBs configured by the source CU to the ancestor nodes that are serving traffic in the upstream conveyed in the said egress BH RLC channel
      Let's consider the example in FIG. 15, where an ingress, marked 15 ms from IAB3, and egress, marked 25 ms to IAB3, BH RLC channel for a top-level node IAB3 are migrated to a target donor. Focusing on the egress BH RLC channel, the source donor CU has configured a PDB of:
         of 25 ms for descendant node IAB5 when serving a BH RLC channel between IAB5 and IAB3, i.e., the top-level node, that is carrying traffic that will be conveyed by IAB3 into the concerned egress BH RLC channel
         of 10 ms for the descendant node IAB7 when serving a BH RLC channel between IAB7 and IAB5 that is carrying traffic that will be conveyed by IAB3 into the concerned egress BH RLC channel
         Hence the cumulative packet delay budget for the concerned egress BH RLC channel is 35 ms. Similarly, the cumulative budget for the ingress BH RLC channel of the IAB3 which is migrated to the target CU is 20 ms, wherein similar to the method (1201a) it is assumed the largest cumulative PDB among the various cumulative PDBs of the paths in which the traffic of the said BH RLC channel is conveyed. In another case, the source CU selects the smaller cumulative PDB, in yet another case the average.
   (1201c): In another method, the source CU may also determine the individual PDB configured to the top-level IAB node, for each individual ingress, for upstream, and egress, for downstream, BH RLC channel configured between the concerned IAB node, i.e., IAB3, and its descendant IAB nodes, whose traffic will be handled by the target CU, as a consequence of the migration of the top-level IAB3 or of some of its BH RLC channels. This method can be for example adopted in the case of full migration, in which the whole top-level node and its context as well as the descendant IAB nodes and their contexts are migrated to the target CU. That is because in this case, the F1/RRC connectivity of the top-level IAB node, descendant IAB nodes, and UEs is transferred to the target CU which needs to know the configurations and QoS requirements, including the PDB, of all the BH RLC channels and DRBs that are migrated to the target.
   (1201d): A method for the source CU to indicate the end-to-end latency requirements of the one or more traffics, e.g., a QoS flow(s), conveyed in the migrating BH RLC channel and that can be derived from the 5QI indicated by the core network for such traffic, i.e., QoS flow.
   (1201e): A method in which the above (1201a-d) values are computed and indicated per BH RLC channel per BAP destination, i.e., for each BAP destination whose traffic is conveyed in this BH RLC channel, the IAB node determines a separate cumulative/individual PDB. For example, from the example in FIG. 15, in which the traffic conveyed in the migrating ingress BH RLC channel is conveyed to two different destinations, i.e., IAB7 and IAB4, the source CU indicates two cumulative PDBs for the said ingress BH RLC channel, i.e. a PDB of 10 ms for the IAB4 destination, and a PDB of 5+15=20 ms for the IAB7 destination.
Transmitting, being an example of action 1202, the indication such as a PDB indication message to the target donor CU, being an example of the second radio network node 16, comprising values computed in one or more of the above actions (1201a-d) for each BH RLC channel, and optionally for each BAP destination whose traffic is conveyed in this BH RLC channel, of an IAB node that is conveying traffic that will be transmitted via the target CU.
   In one example, such indication may be carried in the handover preparation phase, e.g., as part of the Handover Request message, or in DC procedures, e.g., in the S-Node Addition Request message, or in S-Node Modification Request
Receiving, being an example of action 1203, a response indicating confirmation or rejection such as a PDB acknowledgment message from the target donor CU, indicating that
   The QoS requirements, including the PDB indicated in action 1202, can be handled by the target donor, and as a consequence, configuring the concerned IAB node to perform the migration, e.g., transmitting to the concerned IAB node the HO command, or and SCG configuration message for DC configuration. Such message may also indicate a new cumulative PDB for traffic from/to the IAB target donor to/from the top-level node, for example if the cumulative PDB can be smaller than the one indicated in action 1202.
   The QoS requirements, including the PDB indicated in action 1202 cannot be handled by the target donor, and wherein such message may contain the cumulative PDB that can be sustained by the target donor CU for each BH RLC channel indicated in action 1202.
(Optionally) Determining, being an example of action 1204, a new set of PDBs for the descendant IAB nodes in case the target donor cannot handle the cumulative PDB indicated in action 1202, such that the latency requirement of the traffic conveyed in the BH RLC channel can be guaranteed end-to-end, i.e., from the access node to the target donor.
   Let's assume that according to the method, action 1201a, and FIG. 13, the cumulative PDB for the concerned ingress BH RLC channel (dark green) from the donor to the top-level-level IAB node is 45 ms, and that the target donor CU indicated in action 1203 that only a cumulative PDB of 50 ms can be sustained by the IAB ancestor node controlled by the said target CU that are serving traffic to the top-level IAB node. The source CU then determines the remaining packet delay budget for the traffic carried by such ingress BH RLC channel from the top-level node to the destination via the descendant nodes and reconfigure the descendant nodes with a new set of PDBs such that the latency requirements are still fulfilled. For example, from FIG. 15, assuming that the latency requirement end-to-end from the donor to the IAB access node for the traffic carried in the migrating ingress BH RLC channel is 65 ms, then the remaining PDB is 15 ms, and the PDB of the IAB3 and IAB5 for the BH RLC channels carrying such traffic should be reconfigured accordingly
   This action 1204 is optional since it may be performed in the case of proxy-based inter-CU migration, in which the descendant IAB nodes of the migrating IAB node maintains the RRC and F1 connectivity with the first radio network node (source donor).
(Optionally) Transmitting a migration confirmation message on the basis of the outcome of action 1204 to the target CU to trigger the migration in case in action 1203, the target CU indicated that the PDB indicated in action 1202 cannot be handled by the target donor.

Embodiments herein also define methods for the second radio network node 16, such as a target CU, a target donor CU, or CU2, and comprises one or more of the following:
Receiving, being an example of action 1211, the indication such as the PDB indication message from the source donor CU, including values computed in (1201a-d) for each BH RLC channel (and optionally for each BAP destination whose traffic is conveyed in this BH RLC channel) of an IAB node that is conveying traffic that will be transmitted via the target CU.
Determining, being an example of action 1212, whether the indicated cumulative PDBs can be sustained by the ancestor nodes of the migrating top-level node (for upstream and downstream) and by the top-level IAB node (for upstream), wherein the ancestor nodes are the IAB nodes controlled by the target CU and that may serve the traffic (or a portion of it) for the top-level IAB node and its descendant IAB nodes.
   For example, from FIG. 13, if the value provided in action 1211 is the cumulative packet delay budget from/to the target donor to/from the top-level-level IAB node (as per (1201a)), i.e. the target donor determines whether a cumulative PDB value of 45 ms can be sustained in the downstream direction by the donor DU2, IAB1, IAB2, and IAB4 when they are serving traffic conveyed in the ingress BH RLC channel for the top-level node that may be migrated to the target donor. Similarly, the target donor determines whether a cumulative PDB value of 20 ms can be sustained in the upstream direction by the top-level IAB node, IAB4, IAB2, and IAB1.
   In another example, the target donor may determine the cumulative packet delay budget from/to the target donor to/from the top-level-level IAB node by combining (1201b) and (1201d), i.e. by subtracting the cumulative packet delay budget from/to the concerned top-level IAB node to/from the IAB access node (1201b) from the end-to-end delay of the traffic(s) (1201d), i.e. QoS flow(s), carried in the concerned migrating BH RLC channel.
   Whether the cumulative PDB can be sustained or not in the target donor may depend for example on the load of the ancestor nodes, on physical radio resources usage, amount of UEs/DRBs/BH RLC channels already established, etc
Configuring, being an example of action 1213, the ancestor nodes (for upstream and downstream traffic) and the top-level IAB node (for upstream traffic) such that the cumulative PDB from/to the target donor to/from the top-level-level IAB node matches or it is smaller than the cumulative PDB indicated in action 1211. For example, the target donor may equally split the PDB across the ancestor nodes and top-level node. This action is performed only in case the action 1212 implies that the cumulative PDB can be sustained in the target donor
Transmitting, being an example of action 1214, the response such as the PDB acknowledgment message to the source donor CU, indicating that
   The QoS requirements, including the PDB indicated in action 1211 can be handled by the target donor. Such message may also indicate a new cumulative PDB for traffic from/to the IAB target donor to/from the top-level node, for example if the cumulative PDB can be smaller than the one indicated in action 1202.
   The QoS requirements, including the PDB indicated in action 1211 cannot be handled by the target donor, and wherein such message may contain the cumulative PDB that can be sustained by the target donor CU for each BH RLC channel indicated in action 1211.
(Optionally), Receiving a migration confirmation message from the source donor and configure the ancestor nodes and the top-level node according to the cumulative PDB determined in action 1212.

### Handling of Backhaul Channels.

For load balancing purpose, the top-level IAB node may be configured to have simultaneous connectivity to two donors, e.g., dual connectivity, where the traffic is routed via both source CU and target CU (target Donor DU and its descendent IAB nodes), i.e., via the first radio network node 12 and the second radio network node 16. In such case, source CU, depending upon whether the target CU can fulfil PDB requirements or not, may decide how to split, i.e., offload to another CU, the BH traffic such that:
If target CU can meet the PDB requirements, any BH RLC channels, identified by BH RLC Channel IDs, are routed via new path.
If target CU cannot meet the PDB requirements, source CU identifies the BH RLC Channel IDs which are delay tolerant, QoS in terms of latency is relaxed/not strict. For UL traffic, target CU provides the BH RLC Channel IDs to top-level IAB node so that the IAB node can route the UL traffic via new path. Further, for DL traffic, the source CU configures the BH RLC channel of only the delay tolerant traffic to be offloaded via target CU, target donor and its descendent nodes serving the top-level node, for the BH RLC traffic in DL.
If target CU can provide lower PDB values than the source, in such case source CU may prioritize to map the BH RLC channels of delay sensitive traffic, strict QoS in terms of latency, to be routed via new path, i.e., the target donor.

Thus, the first radio network node 12 may split BH traffic based on the response from the second radio network node 16 and particular based on indicated possible PDB values from the second radio network node 16.

The above handling of BH RLC channel can be applied to other QoS parameter as well; for example, considering the bit rate requirements.

### Intra-Donor Latency Handling.

As explained in and exemplified above, the proxied traffic from/to source CU may reach target donor DU directly or via target CU, where the latency may be different from the corresponding “wired” path in the source donor, i.e., the latency between the source CU and source donor DU. In case the aforementioned “wired” latencies are different, they need to be considered, e.g., explicitly indicated when applicable, by the source and target CU, i.e., taken into account when expressing the total delay budgets.
For example, if source donor wants to indicate the total PDB between the donor and top-level node, this value needs to include the intra-donor latency, between source CU and source donor DU. When target CU configures the path towards the top-level node, it may need to consider the latency between the source CU and target donor DU.

### Handling of Control Plane BH RLC Channels.

The control plane traffic may have even stricter latency requirements. As explained above, while the BH RLC channel configuration messages in TS 38.473 v. 16.4.0, for user plane BH RLC channels, reuse the QoS information elements pertaining to legacy DRBs, the IAB-specific Control Plane Traffic Type IE indicates the priority of a control plane BH RLC channel, where 1 has the highest priority. The interpretation of each priority value, i.e., what this means in terms of performance requirement, is configured to the network nodes.

The above considerations are based on PDB, which is inherent to BH RLC channels carrying user plane traffic. Since control plane BH RLC channels are also subject to migration to another donor, all considerations above equally apply to control plane BH RLC channels, whereas the considerations about the total PDB between two network nodes, e.g., donor and top-level node, for user plane BH RLC channels, in case of control plane BH RLC channels, corresponds to the number of hops between these two nodes, and the BH RLC channel priority on each hop.
For example, in FIG. 14, the cumulative PDB for the path DU1-IAB1-IAB2-IAB3 is 45 ms. The corresponding information for control plane BH RLC channels on the same path, indicated to the target CU may be, e.g., “3 consecutive hops, with BH RLC channels on each hop have priority 2”.

In case the target CU is not configured with the same interpretation of control plane channel priority as the source CU, the source CU may report this interpretation to the target CU.
For example, “control plane channel priority 1 corresponds to 3 ms latency on the corresponding hop”.

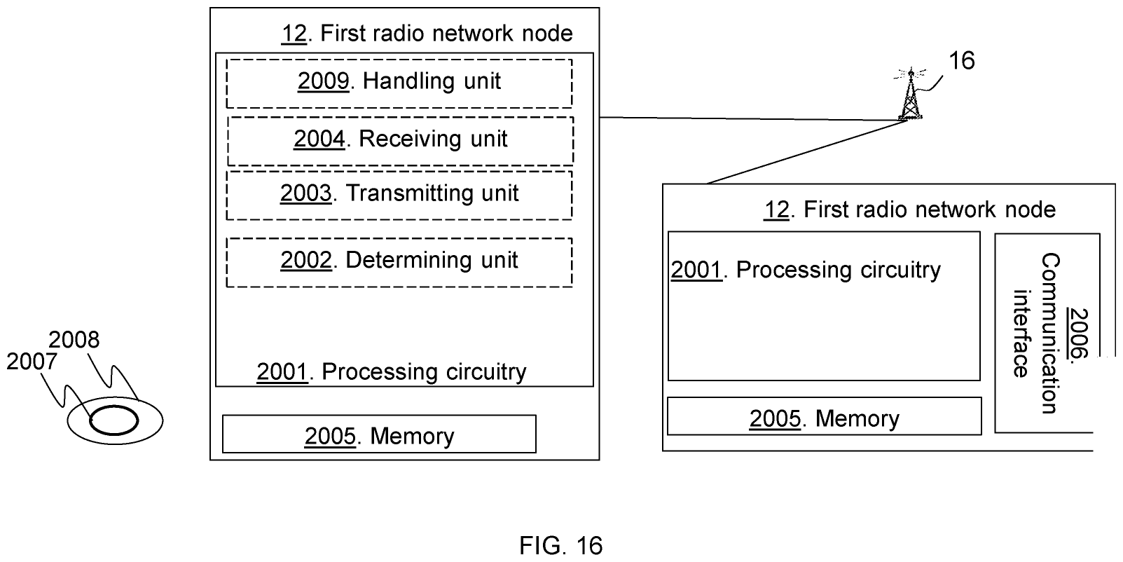

FIG. 16 is a block diagram depicting the first radio network node 12 such as an IAB node, e.g., a first donor node or a first donor CU, for handling communication in a wireless communications network 1 according to embodiments herein. For example, handling migration of the second network node 15 to the second radio network node 16. The first radio network node 12 may be a first central unit and the second radio network node 16 may be a second central unit. The second network node 15 may be an IAB node.

The first radio network node 12 may comprise processing circuitry 2001, e.g. one or more processors, configured to perform the methods herein.

The first radio network node 12 may comprise a determining unit 2002. The first radio network node 12, the processing circuitry 2001, and/or the determining unit 2002 may be configured to determine or obtain the delay information for the one or more channels associated with the second network node 15. The first radio network node 12, the processing circuitry 2001, and/or the determining unit 2002 may be configured to obtain delay information such as cumulative packet delay budget, for one or more channels associated with the second network node 15 migrating to the second radio network node 16, wherein the delay information indicates a delay (a cumulative delay) between at least a plurality of network nodes, e.g., over at least two hops related to the second network node 15. For example, the first radio network node 12, the processing circuitry 2001, and/or the determining unit 2002 may be configured to obtain the delay information by one or more of the following: determine the cumulative packet delay budget for one or more channels between two or more network nodes, for example, from/to the first radio network node 12 to/from the second network node 15: determine the cumulative packet delay budget for one or more channels from/to the second network node 15 to/from another network node i.e. the cumulative packet delay budget from/to the concerned top-level IAB node to/from the IAB access node associated to such BH RLC channel; and obtain the individual PDB configured to the second network node 15, for each individual ingress (for upstream) and egress (for downstream) BH RLC channel configured between the concerned second network node 15, and its descendant IAB nodes; the end-to-end latency requirement of tone or more quality of service flows, conveyed in a migrating BH RLC channel; and the cumulative PDB value computed and indicated per BH RLC channel per BAP destination.

The first radio network node 12 may comprise a transmitting unit 2003, e.g. a transmitter and/or a transceiver. The first radio network node 12, the processing circuitry 2001, and/or the transmitting unit 2003 is configured to transmit the indication to the second radio network node 16, indicating the obtained delay information for the one or more channels associated with the second network node 15 that is conveying traffic that will be transmitted via the second radio network node 16, wherein the delay information indicates the delay between at least the plurality of network nodes. The first radio network node 12, the processing circuitry 2001, and/or the transmitting unit 2003 may be configured to transmit the indication to the second radio network node 16, indicating the determined delay information for one or more (each) BH RLC channel of the second network node 15 that is conveying traffic that will be transmitted via the second radio network node 16.

The first radio network node 12 may comprise a receiving unit 2004, e.g. a receiver and/or a transceiver. The first radio network node 12, the processing circuitry 2001, and/or the receiving unit 2004 is configured to receive the response from the second radio network node 16 indicating confirmation or rejection to be able to meet the requirement of delay as indicated by said transmitted indication. The received response may indicate the possible packet delay budget at the second radio network node 16.

The first radio network node 12 may comprise a handling unit 2009. The first radio network node 12, the processing circuitry 2001, and/or the handling unit 2009 may be configured to perform an action based on the response, e.g. operate based on the response. The first radio network node 12, the processing circuitry 2001, and/or the handling unit 2009 may be configured to perform the action by initiating a migration of the second network node, or parts of its traffic, to the second radio network node 16, or re-determining a second delay information taking the response into consideration. The first radio network node 12, the processing circuitry 2001, and/or the handling unit 2009 may be configured to perform the action by performing one or more of the following: initiating an Inter CU load sharing; identifying a potential new parent IAB node under different CU: selecting best CU or Cell to perform load sharing or migration. Thus, either initiate migration, or re-determine delay information taking the response into consideration.

The first radio network node 12 further comprises a memory 2005. The memory 2005 comprises one or more units to be used to store data on, such as indications, headers, destination address, delay information, PDB information, signal measurements, thresholds, data related to nodes, and applications to perform the methods disclosed herein when being executed, and similar. Furthermore, the first radio network node 12 may comprise a communication interface 2006 such as comprising a transmitter, a receiver and/or a transceiver, and/or one or more antennas.

The methods according to the embodiments described herein for the first radio network node 12 are respectively implemented by means of e.g. a computer program product 2007 or a computer program, comprising instructions, i.e., software code portions, which, when executed on at least one processor, cause the at least one processor to carry out the actions described herein, as performed by the first radio network node 12. The computer program product 2007 may be stored on a computer-readable storage medium 2008, e.g., a disc, a universal serial bus (USB) stick or similar. The computer-readable storage medium 2008, having stored thereon the computer program product, may comprise the instructions which, when executed on at least one processor, cause the at least one processor to carry out the actions described herein, as performed by the first radio network node 12. In some embodiments, the computer-readable storage medium may be a transitory or a non-transitory computer-readable storage medium. Thus, embodiments herein may disclose a first radio network node 12 for handling communication in a wireless communications network, wherein the first radio network node 12 comprises processing circuitry and a memory, said memory comprising instructions executable by said processing circuitry whereby said first radio network node 12 is operative to perform any of the methods herein.

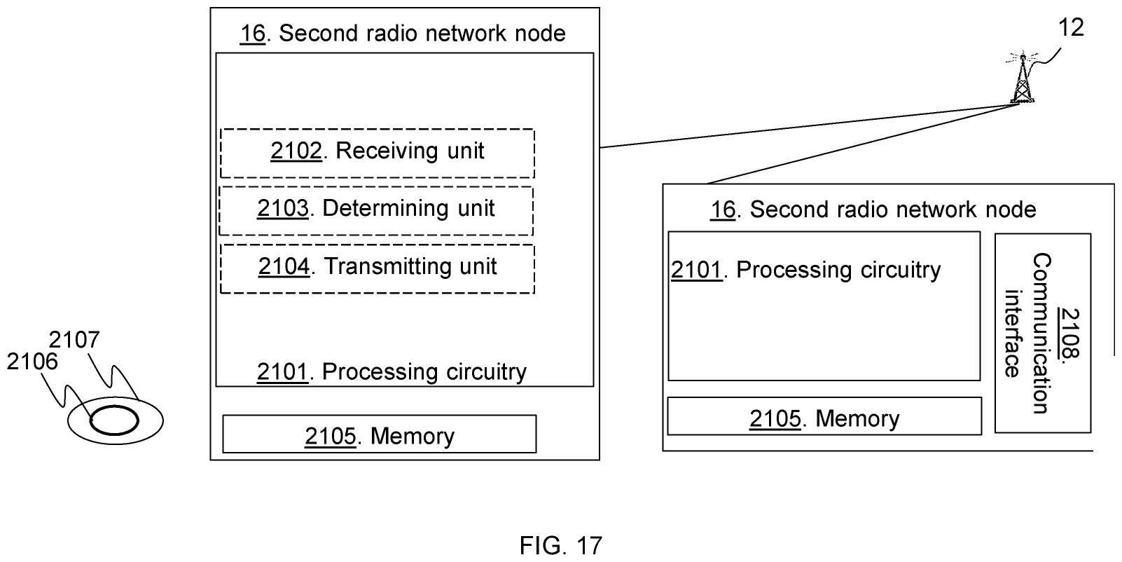

FIG. 17 is a block diagram depicting the second radio network node 16 such as a IAB donor node or second CU, for handling communication in a wireless communications network 1 according to embodiments herein. For example, handling migration of the second network node 15 from the first radio network node 12 to the second radio network node 16. The first radio network node 12 may be a first central unit and the second radio network node 16 may be a second central unit. The second network node 15 may be an IAB node.

The second radio network node 16 may comprise processing circuitry 2101, e.g. one or more processors, configured to perform the methods herein.

The second radio network node 16 may comprise a receiving unit 2102, e.g. a receiver or a transceiver. The second radio network node 16, the processing circuitry 2101, and/or the receiving unit 2102 is configured to receive from the first radio network node 12 the indication, indicating the delay information for the one or more channels associated with the second network node 15 that is conveying traffic that will be transmitted via the second radio network node 16, wherein the delay information indicates a delay between at least a plurality of network nodes. The indication may indicate the delay information for each BH RLC channel of the second network node 15 that is conveying traffic that will be transmitted via the second radio network node 16. The delay information may comprise one or more of the following: the cumulative packet delay budget for one or more channels between two or more network nodes for example from/to the first radio network node 12 to/from the second network node 15; the cumulative packet delay budget for one or more channels from/to the second network node 15 to/from another network node i.e. cumulative packet delay budget from/to the concerned top-level IAB node to/from the IAB access node associated to such BH RLC channel; or individual PDB configured to the second network node 15, for each individual ingress (for upstream) and egress (for downstream) BH RLC channel configured between the concerned second network node 15 and its descendant IAB nodes; the end-to-end latency requirement of tone or more quality of service flows, conveyed in a migrating BH RLC channel; and the cumulative PDB value computed and indicated per BH RLC channel per BAP destination.

The second radio network node 16 may comprise a determining unit 2103. The second radio network node 16, the processing circuitry 2101, and/or the determining unit 2103 is configured to determine whether the indicated delay information can be sustained by the one or more network nodes associated with the second radio network node 16. The second radio network node 16, the processing circuitry 2101, and/or the determining unit 2103 may be configured to determine the possible PDB of network nodes associated with the second radio network node 16, for example, amount of possible PDB of network nodes associated with (served by) the second radio network node 16.

The second radio network node 16 may comprise a transmitting unit 2104, e.g. a transmitter or a transceiver. The second radio network node 16, the processing circuitry 2101, and/or the transmitting unit 2104 is configured to transmit the response to the first radio network node 12 confirming or rejecting to be able to meet the requirement of delay as indicated by said received indication. The transmitted response may indicate the possible PDB at the second radio network node 16.

The second radio network node 16 and/or the processing circuitry 2101 may be configured to configure the PDB of network nodes associated with the second radio network node 16. The second radio network node 16 further comprises a memory 2105. The memory 2105 comprises one or more units to be used to store data on, such as indications, delay information, contexts, available resources, measurements, thresholds, data related to nodes, and applications to perform the methods disclosed herein when being executed, and similar. Furthermore, the second radio network node 16 may comprise a communication interface 2108 such as comprising a transmitter, a receiver and/or a transceiver, and/or one or more antennas.

The methods according to the embodiments described herein for the second radio network node 16 are respectively implemented by means of e.g. a computer program product 2106 or a computer program, comprising instructions, i.e., software code portions, which, when executed on at least one processor, cause the at least one processor to carry out the actions described herein, as performed by the second radio network node 16. The computer program product 2106 may be stored on a computer-readable storage medium 2107, e.g. a disc, a universal serial bus (USB) stick or similar. The computer-readable storage medium 2107, having stored thereon the computer program product, may comprise the instructions which, when executed on at least one processor, cause the at least one processor to carry out the actions described herein, as performed by the second radio network node 16. In some embodiments, the computer-readable storage medium may be a transitory or a non-transitory computer-readable storage medium. Thus, embodiments herein may disclose a second radio network node 16 for handling communication in a wireless communications network, wherein the second radio network node 16 comprises processing circuitry and a memory, said memory comprising instructions executable by said processing circuitry whereby said second radio network node 16 is operative to perform any of the methods herein.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are loT capable device, target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

### OTT

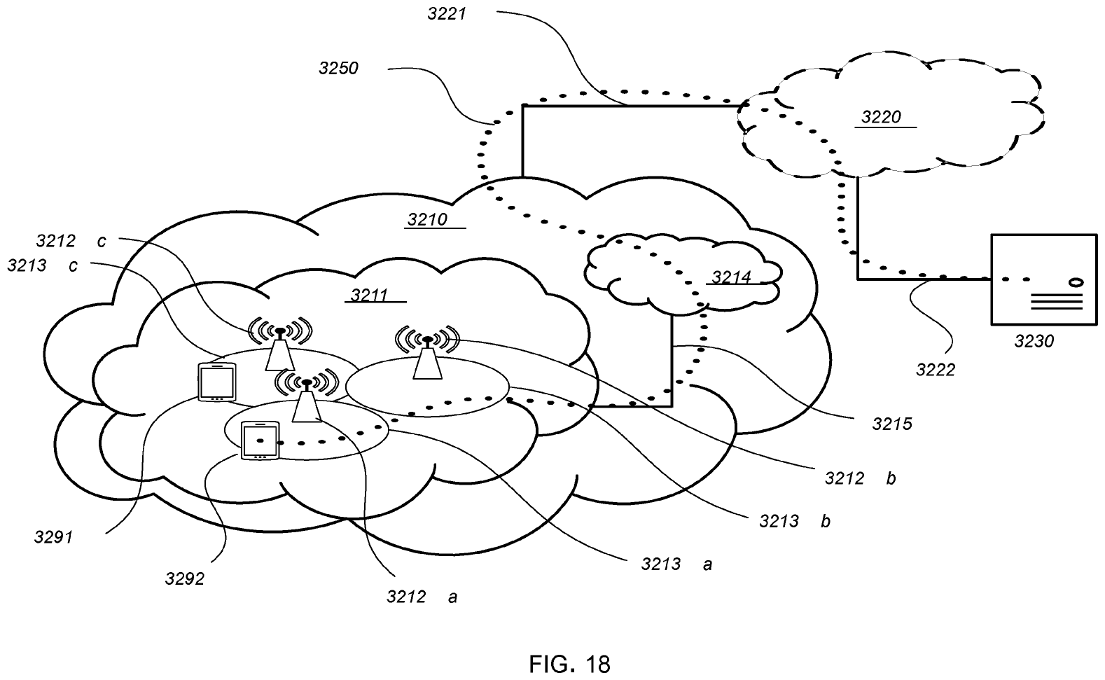

FIG. 18 shows a Telecommunication network connected via an intermediate network to a host computer in accordance with some embodiments. With reference to FIG. 18, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the radio network node 12 above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example being examples of the wireless device 10 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 18 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signalling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

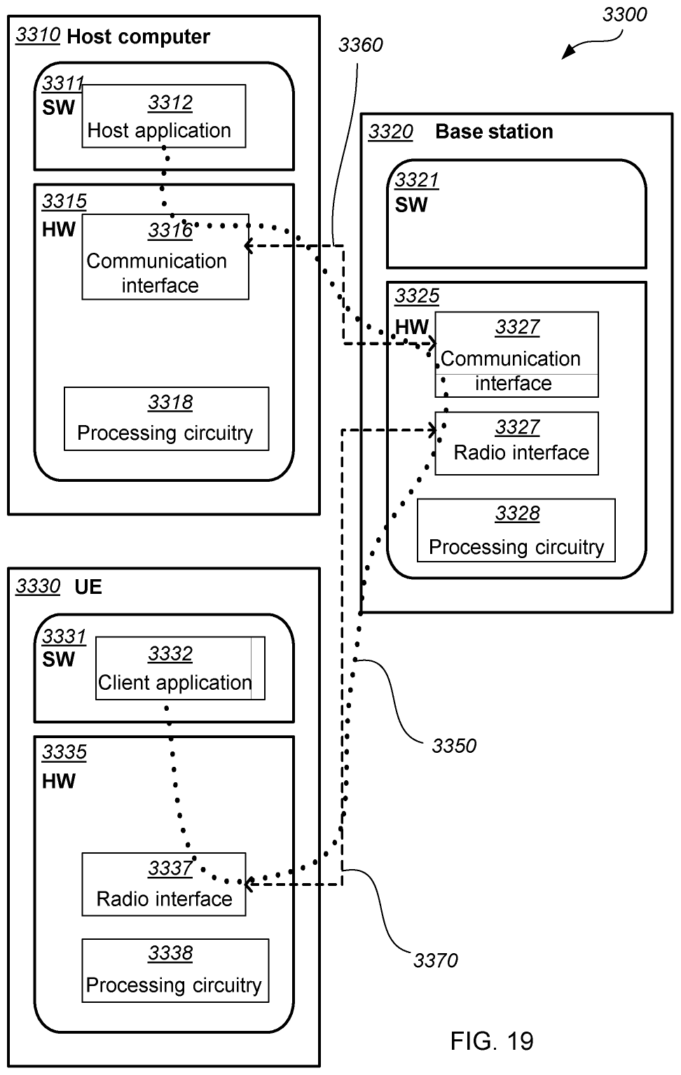

FIG. 19 shows a host computer communicating via a base station and with a user equipment over a partially wireless connection in accordance with some embodiments

Example implementations, in accordance with an embodiment, of the UE, base station and host computer discussed in the preceding paragraphs will now be described with reference to FIG. 19. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 19) served by base station 3320. Communication interface 3326 may be configured to facilitate connection 3360 to host computer 3310. Connection 3360 may be direct or it may pass through a core network (not shown in FIG. 19) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. It's hardware 3333 may include radio interface 3337 configured to set up and maintain wireless connection 3370 with a base station serving a coverage area in which UE 3330 is currently located. Hardware 3333 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 19 may be similar or identical to host computer 3230, one of base stations 3212a, 3212b, 3212c and one of UEs 3291, 3292 of FIG. 18, respectively. This is to say, the inner workings of these entities may be as shown in FIG. 19 and independently, the surrounding network topology may be that of FIG. 18.

In FIG. 19, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments make it possible for handling or managing handover of IAB nodes or traffic of IAB nodes when performing topology adaptation resulting in a reduced delay of packet transmissions and a quick responsiveness.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3333 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and itmay be unknown or imperceptible to base station 3320. Such procedures and functionalities may be known and practiced in the art. In certain embodiments, measurements may involve proprietary UE signalling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

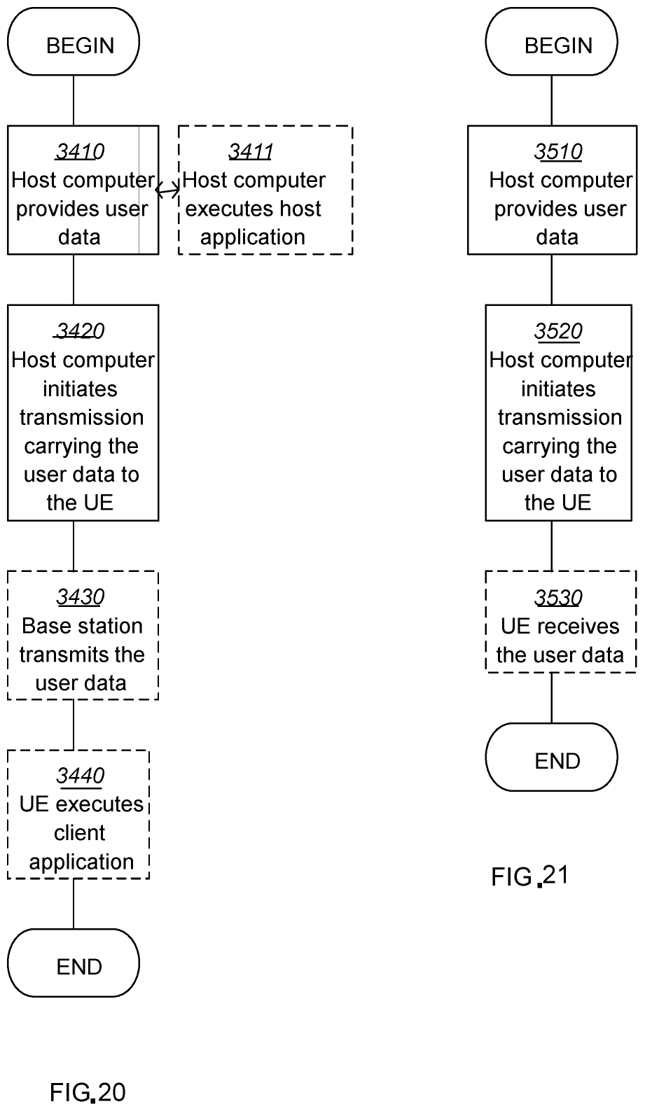

FIG. 20 shows methods implemented in a communication system including a host computer, a base station and a user equipment in accordance with some embodiments.

FIG. 20 is a flowchart illustrating a method implemented in a communication system, in accordance with one embodiment. The communication system includes a host computer, a base station and a UE which may be those described with reference to FIG. 18 and FIG. 19. For simplicity of the present disclosure, only drawing references to FIG. 20 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 21 shows methods implemented in a communication system including a host computer, a base station and a user equipment in accordance with some embodiments.

FIG. 21 is a flowchart illustrating a method implemented in a communication system, in accordance with one embodiment. The communication system includes a host computer, a base station and a UE which may be those described with reference to FIG. 18 and FIG. 19. For simplicity of the present disclosure, only drawing references to FIG. 21 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

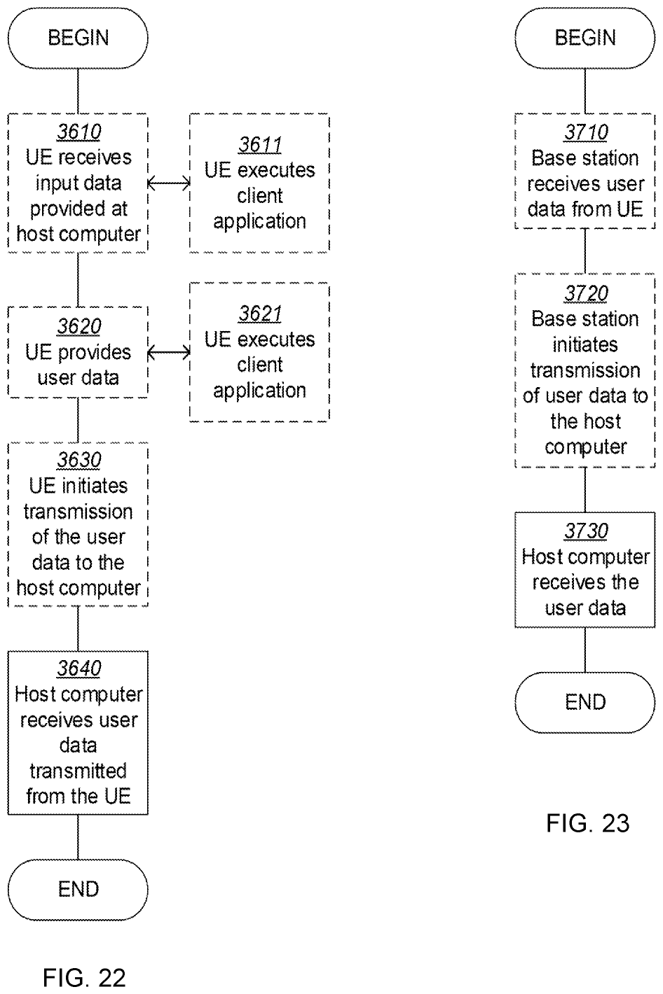

FIG. 22 shows methods implemented in a communication system including a host computer, a base station and a user equipment in accordance with some embodiments.

FIG. 22 is a flowchart illustrating a method implemented in a communication system, in accordance with one embodiment. The communication system includes a host computer, a base station and a UE which may be those described with reference to FIG. 18 and FIG. 19. For simplicity of the present disclosure, only drawing references to FIG. 22 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 23 show methods implemented in a communication system including a host computer, a base station and a user equipment in accordance with some embodiments.

FIG. 23 is a flowchart illustrating a method implemented in a communication system, in accordance with one embodiment. The communication system includes a host computer, a base station and a UE which may be those described with reference to FIG. 18 and FIG. 19. For simplicity of the present disclosure, only drawing references to FIG. 23 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

| Abbreviation | Explanation |
|---|---|
| ACK | (positive) Acknowledgment |
| AUL | Autonomous uplink |
| BLER | Block error rate |
| CCA | Clear channel assessment |
| CO | Channel occupancy |
| COT | Channel occupancy time |
| CWS | Contention window size |
| DL | Downlink |
| eNB | 4G base station |
| gNB | 5G base station |
| IS | In synch |
| MAC | Medium access control |
| MCOT | Maximum channel occupancy time |
| NACK | Negative acknowledgment |
| NDI | New data indicator |
| NR | 3GPP defined 5G radio access technology |
| NR-U | NR unlicensed |
| OOS | out of synch |
| PCI | Physical cell identity |
| PDCCH | A downlink control channel |
| PDU | Protocol data unit |
| PHICH | Physical channel Hybrid ARQ Indicator Channel |
| PLMN | Public land mobile network |
| PSCell | Primary SCG cell |
| PUCCH | Physical Uplink Control Channel |
| PUSCH | Physical Uplink Shared Channel |
| QCI | QoS class identifier |
| QoS | Quality of service |
| RS | Reference signal |
| SCG | Secondary cell group |
| SDU | Service data unit |
| SMTC | SSB-based measurement timing configuration |
| UCI | Uplink Control Information |
| UE | User equipment |
| UL | Uplink |

1.-34. (canceled)

35. A method actions performed by a first radio network node for handling communication in a wireless communications network, the method comprising:
transmitting, to a second radio network node, an indication indicating obtained delay information for one or more channels associated with a second network node that is conveying traffic that will be transmitted via the second radio network node, wherein the delay information indicates a delay between at least a plurality of network nodes; and
receiving, from the second radio network node, a response indicating confirmation or rejection to be able to meet a requirement of delay as indicated by said transmitted indication.

36. The method according to claim 35, further comprising obtaining the delay information for the one or more channels associated with the second network node.

37. The method according to claim 36, wherein obtaining the delay information comprises one or more of the following:
determining a cumulative packet delay budget (PDB) for one or more channels that are from the first radio network node to the second network node or that are from the second network node to the first radio network node;
determining a cumulative PDB for one or more channels that are from the second network node to another network node or that are from another network node to the second network node;
obtaining an individual PDB configured to the second network node, for each individual ingress and egress backhaul (BH) radio link control (RLC) channel configured between the concerned second network node and its descendant Integrated Access Backhaul (IAB) nodes;
an end-to-end latency requirement of one or more quality of service flows, conveyed in a migrating BH RLC channel; or
a cumulative PDB value computed and indicated per BH RLC channel per Backhaul Adaptation Protocol (BAP) destination.

38. The method according to claim 35, wherein the delay between the at least a plurality of network nodes comprises a cumulative delay between network nodes over at least two hops related to the second network node.

39. The method according to claim 35, wherein the received response indicates possible packet delay budget at the second radio network node.

40. The method according to claim 35, further comprising performing an action based on the response.

41. The method according to claim 40, wherein performing the action comprises initiating a migration of the second network node, or parts of its traffic, to the second radio network node, or re-determining second delay information taking the received response into consideration.

42. The method according to claim 40, wherein performing the action comprises one or more of the following: initiating Inter central unit (CU) load sharing; identifying a potential new parent Integrated Access Backhaul (IAB) node under a different CU: selecting a CU or Cell to perform Load Sharing or migration.

43. The method according to claim 35, wherein the second network node is an Integrated Access Backhaul (IAB) node.

44. The method according to claim 35, wherein the first radio network node is a first central unit and the second radio network node is a second central unit.

45. A method performed by a second radio network node for handling communication in a wireless communications network, the method comprising
receiving, from a first radio network node, an indication indicating delay information for one or more channels associated with a second network node that is conveying traffic that will be transmitted via the second radio network node, wherein the delay information indicates a delay between at least a plurality of network nodes;
determining whether the indicated delay information can be sustained by one or more network nodes associated with the second radio network node; and
transmitting a response to the first radio network node confirming or rejecting to be able to meet a requirement of delay as indicated by said received indication, based on the determination.

46. The method according to claim 45, wherein the delay information comprises one or more of the following:
a cumulative packet delay budget (PDB) for one or more channels that are from the first radio network node to the second network node or that are from the second network node to the first radio network node;
a cumulative PDB for one or more channels that are from the second network node to another network node or that are from another network node to the second network node;
an individual PDB configured to the second network node, for each individual ingress and egress backhaul (BH) radio link control (RLC) channel configured between the concerned second network node and its descendant Integrated Access Backhaul (IAB) nodes;
an end-to-end latency requirement of one or more quality of service flows, conveyed in a migrating BH RLC channel; and
a cumulative PDB value computed and indicated per BH RLC channel per Backhaul Adaptation Protocol (BAP) destination.

47. The method according to claim 45, wherein determining whether the indicated delay information can be sustained comprises determining a possible packet delay budget (PDB) of network nodes associated with the second radio network node, and wherein the transmitted response indicates the possible PDB at the second radio network node.

48. The method according to claim 45, further comprising configuring packet delay budget (PDB) of network nodes associated with the second radio network node.

49. The method according to claim 45, wherein the second network node is an Integrated Access Backhaul (IAB) node.

50. The method according to claim 45, wherein the first radio network node is a first central unit and the second radio network node is a second central unit.

51. A first radio network node for handling communication in a wireless communications network, wherein the first radio network node comprises:
processing circuitry configured to:
transmit, to a second radio network node, an indication indicating obtained delay information for one or more channels associated with a second network node that is conveying traffic that will be transmitted via the second radio network node, wherein the delay information indicates a delay between at least a plurality of network nodes; and
receive, from the second radio network node, a response indicating confirmation or rejection to be able to meet a requirement of delay as indicated by said transmitted indication.

52. The first radio network node according to claim 51, wherein the processing circuitry node is further configured to obtain the delay information for the one or more channels associated with the second network node.

53. The first radio network node according to claim 52, wherein the processing circuitry is configured to obtain the delay information by one or more of the following:
determining a cumulative packet delay budget (PDB) for one or more channels that are from the first radio network node to the second network node or that are from the second network node to the first radio network node;
determining a cumulative PDB for one or more channels that are from the second network node to another network node or that are from another network node to the second network node;
obtaining an individual PDB configured to the second network node, for each individual ingress and egress backhaul (BH) radio link control (RLC) channel configured between the concerned second network node and its descendant Integrated Access Backhaul (IAB) nodes;
an end-to-end latency requirement of one or more quality of service flows, conveyed in a migrating BH RLC channel; or
a cumulative PDB value computed and indicated per BH RLC channel per Backhaul Adaptation Protocol (BAP) destination.

54. The first radio network node according to claim 51, wherein the delay between the at least a plurality of network nodes comprises a cumulative delay between network nodes over at least two hops related to the second network node.

55. The first radio network node according to claim 51, wherein the received response indicates a possible packet delay budget at the second radio network node.

56. The first radio network node according to claim 51, wherein the processing circuitry is further configured to perform an action based on the response.

57. A second radio network node for handling communication in a wireless communications network, wherein the second radio network node comprises:
processing circuitry configured to:
receive, from a first radio network node, an indication indicating delay information for one or more channels associated with a second network node that is conveying traffic that will be transmitted via the second radio network node, wherein the delay information indicates a delay between at least a plurality of network nodes;
determine whether the indicated delay information can be sustained by one or more network nodes associated with the second radio network node; and
transmit, to the first radio network node, a response confirming or rejecting to be able to meet a requirement of delay as indicated by said received indication, based on the determination.

58. The second radio network node according to claim 57, wherein the delay information comprises one or more of the following:
a cumulative packet delay budget (PDB) for one or more channels that are from the first radio network node to the second network node or that are from the second network node to the first radio network node;
a cumulative PDB for one or more channels that are from the second network node to another network node or that are from another network node to the second network node;
an individual PDB configured to the second network node, for each individual ingress and egress backhaul (BH) radio link control (RLC) channel configured between the concerned second network node and its descendant Integrated Access Backhaul (IAB) nodes;
an end-to-end latency requirement of one or more quality of service flows, conveyed in a migrating BH RLC channel; and
a cumulative PDB value computed and indicated per BH RLC channel per Backhaul Adaptation Protocol (BAP) destination.

59. The second radio network node according to claim 57, wherein the processing circuitry is configured to determine whether the indicated delay information can be sustained by determining a possible packet delay budget (PDB) of network nodes associated with the second radio network node, and the transmitted response indicates the possible PDB at the second radio network node.

60. A computer-readable storage medium having stored thereon a computer program product comprising instructions which, when executed on at least one processor, cause the at least one processor to carry out the method according to claim 35, as performed by a first radio network node.

61. A computer-readable storage medium having stored thereon a computer program product comprising instructions which, when executed on at least one processor, cause the at least one processor to carry out the method according to claim 45, as performed by a second radio network node.
